(19) United States
(12) Patent Application Publication
(10) Pub. No.: US 2013/0226771 A1
(43) Pub. Date: Aug. 29, 2013

(54) COMPLEX TRADING MECHANISM

(71) Applicant: Patricia MACRI LASSUS, Palo Alto, CA (US)

(72) Inventor: Patricia MACRI LASSUS, Palo Alto, CA (US)

(21) Appl. No.: 13/835,787

(22) Filed: Mar. 15, 2013

Related U.S. Application Data
(63) Continuation-in-part of application No. 13/013,611, filed on Jan. 25, 2011.
(60) Provisional application No. 61/298,542, filed on Jan. 26, 2010.

(51) Int. Cl. G06Q 40/04

(52) U.S. Cl. CPC G06Q 40/04
USPC 705/37

(57) ABSTRACT

Various embodiments of the present technology, an apparatus for trading, are described. In various embodiments, the trading apparatus has a trading mechanism including a message space that defines admissible orders. In various embodiments, the trading apparatus supports orders from either multi-unit orders, multi-item orders, or a combination of multi-unit orders and multi-item orders. In various embodiments, said trading apparatus comprises an order receiver for receiving admissible orders from at least one trader i. In various embodiments, said trading apparatus comprises an order storage module for storing said admissible submitted orders. In various embodiments said trading apparatus comprises a trade generator for generating trades based on said admissible submitted orders and said trading mechanism. In one embodiment, prices corresponding to the generated allocations and transfers are not determined exogenously. In various embodiments, said trading apparatus comprises a reporting module for reporting said trades.

### RELATED APPLICATIONS

This application is a continuation-in-part of and claims the benefit of co-pending patent application Ser. No. 13/013,611, Attorney Docket Number GDSX-001, entitled “COMPLEX TRADING MECHANISM,” with filing date Jan. 25, 2011. The application with Ser. No. 13/013,611 claims priority to U.S. Provisional Application No. 61/298,542, entitled “Market Design Related,” with filing date Jan. 26, 2010.

### BACKGROUND

In general, at the bidding stage of auctions (ex-ante), bidders face significant uncertainty about information that they care about. The information affects their valuations for the auction items and/or their optimal bidding strategies for the items, thereby affecting their bids.

Some of this ex-ante unknown, but relevant information includes information that will be realized (and potentially available to the bidders) ex-post, once the auction is run. In the following, bidders are generally referred to as buyers for ease of exposition, but the analogue applies to sellers.

Bidders may, for example, care about features of the overall allocation, in that a bidder's valuation for the goods or set of goods he won may depend on how much total quantity was sold in a multi-unit auction, or on who else won which item in an auction, and at what price. For example, a bidder in a securities auction may care about the total quantity issued because it would likely affect the liquidity of the security in the secondary market. Further, a bidder who has an equivalent of a 20% of market share in a liquidation auction for a retail chain or in a privatization of a retail chain may care about whether the market share of the next largest winner is at most a 5%, or whether the remaining 80% of the market share is split evenly among two other bidders, because winner's market shares would likely affect the kind of competition ensuing in the retail market after the auction was settled.

Bidders may also care about information regarding the clearing conditions of the auction, such as the level of oversubscription, what the average winning bid was in a multi-unit auction, or information about on other statistics of winning and/or losing bids in an auction. For example, the U.S. treasury and other governments routinely publish the average winning bids and other statistics once a treasury auction is run. If bidders could foresee this information, they may choose to bid more aggressively the more an auction is oversubscribed. Additionally or in the alternative, the bidders may adjust their estimate of the value of items that have common values or interdependent values (that is, a bidder's valuation for an item depends at least in part on the value other bidders attach to the item).

Moreover, consider the case in which a number of auctions are held, for example, 3 auctions a day for a given stock. A bidder trying to buy stock that day may care about which of the auctions will be more liquid (in that a large number of sellers will be selling), so that he can minimize his price impact on the clearing price by choosing to bid in that auction which is most liquid.

Bidders know that the amount they bid in auctions will likely affect both their probability of winning an item, as well as, in many auction formats, the price they pay for units won. The uncertainty at the bidding stage may lead bidders to shade bids (that is, bid less aggressively), reduce the quantity or the set of goods they bid on, or refrain from bidding, because they fear ending up paying more than was necessary to win, or overpaying in that the price they pay is above their ex-post estimate of the goods' values.

A well-known term capturing the risk of overpaying in the context of common values auctions is the “winner's curse”: conditional on winning, a bidder has to adjust his estimate of the value of the object downwards. Anticipating the winner's curse ex-ante, bidders submit less aggressive bids, even more so, if bidders know that their aggressive winning bids also increases the price they paid on units won (for example in a multi-unit auction).

Another related concept is that of “exposure risk”. A buyer who wants to buy, for example, a bundle of goods that he considers complements, but who can submit bids for individual goods only, risks being stuck winning only a few rather than all the goods in the bundle, thus winning a set of goods for which his valuation is much lower. As a result, the buyer may refrain from bidding on the items, or reduce the prices he bids. A buyer who bids less aggressively because he risks ending up winning a set of goods when the overall allocation of goods is unfavorable to him, would thus be dealing with a more general version of the exposure risk above.

Bid shading or reduced bidder participation, in turn, may result in suboptimal allocations, including too little volume exchanged or too little revenue generated.

### SUMMARY

This Summary is provided to introduce a selection of concepts in a simplified form that are further described below in the Description of Embodiments. This Summary is not intended to identify key features or essential features of the claimed subject matter, nor is it intended to be used as an aid in determining the scope of the claimed subject matter.

Various embodiments of the present technology, an apparatus for trading, are described. In various embodiments, the trading apparatus has a trading mechanism including a message space that defines admissible orders. In various embodiments, the trading apparatus supports orders from either multi-unit orders, multi-item orders, or a combination of multi-unit orders and multi-item orders. In various embodiments, said trading apparatus comprises an order receiver for receiving admissible orders from at least one trader i, said orders comprising at least one admissible complex order submitted by said trader i, said complex order involving at least one nonzero price and belonging to the group of either multi-unit orders, multi-item orders, or a combination of multi-unit orders and multi-item orders; said complex order including at least one complex condition defined on a state of the world at a clearing; wherein, given said trading mechanism: for at least one set of orders in the set of admissible orders from traders other than trader i, determining whether said complex condition is met is not possible knowing only the information contained in the group of trader i's allocation and transfers in said clearing, trader i's own order history up until the time of said clearing, the time of said clearing, the history of exogenous variables up until the time of said clearing, and other information available to trader i in said trading mechanism up until the time of said clearing; but is possible knowing the information contained in the group of the trade allocation and transfers in said clearing, and the entirety of trading mechanism information up until the time of said clearing. In various embodiments, said trading apparatus comprises an order storage module for storing said admissible submitted orders. In various embodiments said trading apparatus comprises a trade generator for generating trades based on said admissible submitted orders and said trading mechanism. In one embodiment, prices corresponding to the generated allocations and transfers are not determined exogenously. In various embodiments, said trading apparatus comprises a reporting module for reporting said trades.

### DESCRIPTION OF THE DRAWINGS

FIG. 1A is a block diagram of an example system for performing a trading method, in accordance with embodiments of the present technology.

FIG. 1B is a block diagram of an example system for performing a trading method, in accordance with embodiments of the present technology.

FIG. 1C is a block diagram of an example system for performing a trading method, in accordance with embodiments of the present technology

FIG. 2A is a flow diagram of an example method for trading, in accordance with embodiments of the present technology.

FIG. 2B is a flow diagram of an example method for trading, in accordance with embodiments of the present technology.

FIG. 3 is a block diagram of an example computer system used for trading in accordance with embodiments of the present technology.

FIG. 4, is a flow chart of a method for increasing trade volume in a trading mechanism, according to embodiments of the present technology.

FIG. 5 is a flow chart of a method for increasing auction revenue in an auction mechanism, according to embodiments of the present technology.

FIG. 6 is a flow chart of a method for enhancing revenue in a trading mechanism, according to embodiments of the present technology.

FIG. 7 is a method for increasing revenue of a trading mechanism.

FIG. 8 is an auction apparatus, according to embodiments of the present technology.

FIG. 9 is an auction apparatus, according to embodiments of the present technology.

FIG. 10 is an auction apparatus, according to embodiments of the present technology.

FIG. 11 is a trading apparatus, according to embodiments of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “storing”, “generating”, “reporting”, “managing”, “communicating”, “sending”, “comparing”, “executing”, ““enabling”, “utilizing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical computers.

The following is a list of definitions for some of the terminology used herein. A number of other terms, whose definitions are lengthier, are defined in the appropriate sections. Trading mechanisms are considered, as well as the subset of auction mechanisms included therein. Moreover, a simple setting and a richer setting are considered.

A few comments on some of the definitions below are in order. The terms auction and, more generally, mechanism are used in the mechanism design literature and in practice, to refer to a set of rules that are used to generate a trade (or an allocation and transfers/prices) based on a set of bids/orders. At the same time, both in the mechanism design literature and in practice, mechanism refer not only to a set of rules, but also to the act of implementing the rules, as well as to the physical apparatus implementing the rules in practice by running software routines. For example, treasuries in the US are sold via an auction (in particular, a uniform price auction). The term auction refers to the set of rules, as well as to the event in which the treasuries are sold, and to the physical apparatus that was used to do so. Similarly, a standard stock exchange that features a limit order book is a mechanism (a set of rules), as well as the physical apparatus on which trading happens.

The term trading mechanisms here will generally refer to the set of rules (as reflected from the definition below), but the other two common meanings of the term may also sometimes apply, with the appropriate meaning to be inferred from the context (as is customary in both academia and practice). For example, a statement such as “the designer runs the auction” or “runs the trading mechanism” clearly implies the second meaning, as opposed to the rules.

Next, the term clearing is common in economics and mechanism design and refers to the clearing of an auction or of a market in the sense of finding (i.e. solving for) the market-clearing price. A more formal definition is below. It is useful to mention that the meaning of “clearing” or to “clear” has nothing to do with the use of the word in the context of “clearing and settlement” done by clearing houses in financial markets, which happens much later after a trade has, say, been determined on a stock exchange by matching a market order against a limit order.

### GENERAL DEFINITIONS

Trading mechanism: refers to a mechanism employed to generate a trade based on a set of orders, and includes a clearing method as well as other trading rules.

Clearing method: Refers to the method (algorithm or rules) used to generate a trade, and includes a trading format, an objective and tie-breaking rules and other rules that may be necessary.

Auction(s) or auction mechanisms: That subset of trading mechanisms, for which the trading format used is an auction format. The term auction henceforth includes typical auctions (in which the bidders buy goods), reverse auctions (in which the bidders sell goods), and double auctions (in which bidders buy and sell goods) for one or more goods (that is, including auctions for single goods and auctions for multiple goods, the latter being referred to as multi-unit auctions henceforth).

It should be understood that the description of embodiments of the present technology with respect to using terminology applying to trading mechanisms also applies to auctions (or auction mechanisms). Further, it should be understood that any description using “auction” terminology also applies to trading, unless specifically noted otherwise herein. Thus, for example, the term “order(s)”, “trader” and “trade results” (or “trade” and “trade allocation and transfers”) in trading mechanisms would apply to auctions as “bid(s)”, “bidder”, and “auction allocation and transfers” and vice versa unless specifically noted otherwise. For ease of exposition, auction terminology is used through most of the document.

Complex auctions or complex auction mechanisms: Auctions (or auction mechanisms) that allow for complex bids. Complex bids are defined in the Structure section.

Complex trading mechanisms: Trading mechanisms that allow for complex orders. Complex orders are defined in the Structure section.

Goods, units, objects, and items: Are interchangeable, and may refer both to tangible and to intangible goods. Moreover, embodiments of the present technology may be applied to a single good or a plurality of goods. The plurality of goods may be multiple identical and/or dissimilar goods. Identical goods may mean that the items are in fact identical (such as bonds in a specific issuance) or that the bidders consider the goods to be close substitutes. As for dissimilar goods, which are also commonly referred to as non-identical goods, the goods could all be dissimilar, or there could be groups of identical goods within the dissimilar goods (for example, if a portfolio is liquidated, containing positions in a number of different stocks).

Finally, throughout this document, reference is made to choices that have to, or can be made about the specific embodiment to be used for a specific application. These choices are up to the auction designer (or mechanism designer), who is likely to be identical with the auctioneer, which is why the terms are used interchangeably in the context of mechanism design choices.

### Simple Setting

Simple setting: A setting for running one-time, sealed bid auctions (or trading mechanisms), for which clearing does not require accessing any information that is outside of the auction, and for which no time component is introduced (if present, a time component would allow to distinguish identical bids a bidder may have submitted at different times). This setting is commonly used in auction applications such as treasury auctions, IPO's, real estate auctions, or spectrum auctions.

Set of admissible bids: The kind of bids that bidders may submit in the auction, that is, the kind of bids that bidders are allowed to submit in the auction. For example, in a multi-unit auction, bidders may be allowed only to express bids stating that they would like to buy up to some number q of shares for up to some price p. If bidders were also allowed to state that they would buy shares only if they win at least some minimum quantity qₘᵢₙ, then the bids with a minimum-quantity-restriction would be a second kind of admissible bid, along with the unconditional bids described first.

Message space: The message space in mechanism design refers to the messages that participants (and the designer) can send to communicate within the mechanism. The message space is chosen (that is, defined) by the mechanism designer, and is an important part of the design. In particular, the bidder's message space defines the set of admissible bids that bidders are allowed to submit to the mechanism. For example, if the mechanism was a standard exchange with a limit order book, then limit orders and market orders, would be included in the trader's message space (alongside the host of other orders, such as immediate or cancel orders, common in exchanges today).

The following terms are introduced for the simple setting, and will be augmented further below, for the richer setting.

Set of submitted bids in the auction: All bids that bidders submit. Some of these bids may be found to be invalid, bidders may cancel bids, or amend their bids.

Set of auction bids, or the set of outstanding, valid bids: A subset of the submitted bids, namely those submitted bids that are valid and outstanding (have not been cancelled or amended by the bidder) at the clearing stage of the auction. The term “valid” is to be interpreted in the common sense of being eligible for inclusion in the auction or trading process. For example, it is common in opening auctions for bidders to submit Limit-on-close (LOC) bids that specify to buy a quantity at a limit price (i.e. these bids are part of the set of admissible bids, just like the market-on-close bids that only specify a quantity to buy). LOC bids, though, can be submitted only up to a certain point in time in the auction, meaning that any LOC bids submitted after that cutoff would be invalid. Similarly, in a one-shot auction, the set of admissible bids may include bids on packages of up to two items, but bidders may be allowed to cancel a bid and resubmit a new one only once for a specific package. If a bidder canceled his second bid on a given package, and submitted yet another new bid, this third bid would be invalid.

Bid information for each individual bid by a bidder i: Includes what would commonly be understood as the bid (which items the bidder bids on, what prices, and any conditions), as well as the bidder's identity.

Bid information for bidder i: Includes the bid information for the collection of bids he submitted and that are valid and outstanding at the clearing stage of the auction.

Bid information for the auction: Includes the bid information for each of the participating bidders.

Bid information excluding bidder i: Is found by removing bidder i's bid information from the auction bid information.

Set of items sold and/or bought in the auction: Emerges at the clearing of the auction, from the candidate set of items to be sold and/or bought at the auction (which is known from the beginning of the auction).

Candidate set of items to be sold and/or bought at the auction: Set of items that may be bought or sold in the auction. In some embodiments or the present technology, the decision as to which items, and/or how many items to buy and/or sell may be made at the clearing stage of the auction (that is, when calculating the auction allocation and transfers, and thus after having collected the bids). For example, the auctioneer may, at the beginning of the auction specify a candidate set of items to be sold by announcing that the quantity of shares to be sold in an auction will be between 1 and 2 million, or that bonds are to be sold with a notional between 1 and 2 billion. At the clearing stage, the auctioneer would then decide on the total quantity sold, based on the submitted bids. Or, the auctioneer may specify a candidate set of auction items sold by announcing that two bonds, A and B, with a combined notional of 2 billion will be auctioned off, and then decide on the split of volume between bond A and B (that is, the set of auction items sold), when clearing the auction. Notice that the difference between the candidate set of items and the set of items that emerges at the clearing naturally exists for double-auctions, as bidders in a double-auction for a stock, for example, know that the stock will be traded (which defines the candidate set), but understand that the total quantity traded (the set of auction items sold or bought) will depend on the bids submitted by the buyers and sellers in the auction.

Auction allocation: Denoted as X={Xᵢ, . . . Xₙ}, specifies, for every participating bidder i, which set of items Xᵢ he bought or sold.

Auction Transfers: Denoted as T={Tᵢ, . . . Tₙ}, specify, for each participating bidder i, which transfers (generally, prices) he paid or received.

Auction allocation and transfers for bidder i in an auction: Denoted as Xᵢ and Tᵢ, respectively, refer to the goods the bidder bought or sold and the prices he paid or received in the auction.

Auction allocation and transfers excluding bidder i: Denoted as X-Xᵢ and T-Tᵢ, respectively, refer to the auction and allocation and transfers after removing the information about Xᵢ and Tᵢ, that is the item(s) bought or sold and the transfer(s) paid or received by bidder i. For example, if buyer i won items A and B for a price of 5 and 6 in an auction for goods A, B, C, and D, then Xᵢ=(X_{iA}, X_{iB}, X_{iC}, X_{iD})=(1,1,0,0) and Tᵢ=(5,6,0,0). Note that the allocation Xᵢ can be positive or negative, depending on whether the good is sold or bough. Thus Xᵢ=(X_{iA}, X_{iB}, X_{iC}, X_{iD})=(1,−1,0,0) may denote that bidder i bought good A and sold good B. Similarly, the transfers for a specific item do not have to be positive (negative transfers may mean that a bidder sold an object), nor do the transfers have to be zero when a bidder “bought” an item (for example in the case when the auction mechanism is applied in auction-like settings with the purpose of coordination), nor do the transfers have to be monetary units (bidders in an auction may be “paying” with points of which they may have a specific amount). Moreover, the way in which Xᵢ and Tᵢ is specified may depend on what is most convenient: for example, it may be convenient to write Xⱼ=100, Tⱼ=7 for a bidder j who won 100 shares in a securities auction at a per share price of $7.

Infra-auction information: Refers to information in messages sent by the auctioneer to bidders, or information somehow made public to bidders in the system. Standard methods for making information public to participants include message boards. In the richer setting described in the following section (in which trading may be continuous), limit order books that make part of the orders in the system public to participants are common, as well as data feeds that publicize trades.

### Richer Setting

Richer setting: Augments the simple setting by including time as a variable (in the sense that, for example, the time at which bids are submitted matters), and/or by connecting the trading mechanism to exogenous variables and/or platforms (where exogenous means outside of the trading mechanism). Embodiments tailored to this setting may be applied to create a trading platform, by, for example, running hourly auctions to buy and sell stocks.

Since this setting is richer than the simple setting, all the capabilities of the embodiments of the invention described in the simple setting still exist in the richer setting (the richer setting only adds to the capabilities of possible embodiments of the invention).

In this setting, any bids submitted, and any other information is time-stamped, which makes it necessary to distinguish between current values of variables at time t, and variable's history up to time t (or time t history, in the following), which is defined as the collection of the variable's values from the start of the auction up until time t. Intra-auction information at time t: Refers to information in messages sent by the auctioneer to bidders, or information somehow made public to bidders in the system at time t within the auction. For ease of exposition, the corresponding term using trading terminology is intra-trade information (as opposed to the lengthy intra-trading mechanism information), which also captures the intuition that this type of information may be sent out between sequences of auctions that are run (i.e. executed) or trades that are executed.

History of intra-auction information at time t: Consists of the collection of intra auction information from the start of the auction until time t.

Intra-auction information for bidder i at time t: Intra-auction information sent to bidder i at time t or, equivalently, information made public to bidder i.

History of intra-auction information up until time t for bidder l (or time t history of intra-auction information): The history of Intra-auction information for bidder i.

Intra-auction information at time t excluding bidder i: Found by removing the intra-auction information for bidder i at time t, from the collection of bidders' time t intra-auction information.

History of intra-auction information up to time t excluding bidder i: Found by removing the information in the history of intra-auction information up to time t for bidder i, from the information contained in the history of intra-auction information up to time t sent to the collection of bidders.

In the richer setting, the auction mechanisms may allow for bids on auction items to depend on exogenous variables, or for bidders to bid directly on goods bought or sold at exogenous platforms. The term exogenous is meant in the sense of “outside” of the auction. For example, complex trading platform A may allow for bids for security X to be pegged to the current midpoint of security X at exchange B, or to the midpoint of the NBBO for security Y, or on any other exogenous variable, such as the temperature in a given city. Or, an order on complex trading platform A may include the instructions to send a market order to exchange B, wherein the quantity for the market order is to be equal to half of the amount of shares executed in the trade on platform A. As another example, complex trading platform A may send out market buy orders to exchanges B and C (for a total of, say, 5,000 shares), when executing a blocks of buy orders and sell orders on platform A (where the block of sell orders was 5,000 shares smaller than the buy order block). More examples are found throughout the specification.

Again, it is important to distinguish between the time t value of an exogenous variable, and the history of values up to time t (which consists of the collection of values, from the start of the auction until time t). For the case of exogenous trading venues, the time t values may refer to the best prices and the available volume at these prices on the exogenous venue, and the history of the values would again be the collection of the values from start of the auction until time t.

Regarding the auction bids, each individual bid for bidder i in the richer setting includes a time stamp, in addition to what was the case in the simple setting. The set of valid, outstanding bids from bidder i at time t consists of all the bids that bidder i submitted from the start of the auction until time t, and which have not expired by time t. Aggregating these bids over all bidders, generates the set of valid, outstanding bids at time t in the auction.

History of bids up to time t for bidder i: includes all bids submitted by that bidder up until time t, including, for example still valid outstanding bids, and expired bids.

The history of auction bids up to time t: Found by aggregating the individual bid histories over all bidders. The history of auction bids up to time t excluding bidder i, is then found by subtracting bidder i's history of auction bids.

In some embodiments, the invention is run as a trading platform, meaning that a series of auctions is run over some time interval, such as a day, or an hour. If so, when talking about the histories described above, the start of the auction is meant not to refer to the start of the current auction, but rather to refer to the start of the first auction in the sequence that the current auction belongs to. The auction designer exercises discretion over the definition of sequences. For example, if auctions are run hourly in any trading day, with the first auction at 9 am and the last one at 5 pm, a natural definition of a sequence may be the set of auctions run on the same day, which would imply that the start time relevant for the histories considered in a 3 pm auction is the 9 am start time of the first auction that was run on the same day.

If auctions are indeed run in sequences, it is useful to also define the history of trades up to time t. This history refers to the information about executed trades (that is, the auction allocations and transfers for auctions that have concluded) from the start time of the sequence of auctions up until the time t. Note that the clearing of the auction may take some time, D, which may matter in high speed trading applications. If so, the history of trades up to time t is meant to include trades that were generated through a clearing process that started at time t (in the sense that it took at inputs the set of valid, outstanding bids at time t). Note that the auctioneer in the present technology has discretion over whether to make none, all, or part of the history of trades available to bidder. In practice, though, regulatory requirements with respect to trade reporting may apply. For example, if a sequence of auctions was held for a stock, regulatory requirements may specify that the price and quantity of each executed trade be reported.

The discussion will begin with a brief overview of embodiments of the present technology. The discussion will then focus on embodiments of the present technology that provide an apparatus and method for trading.

### Overview

In general, embodiments of the present technology provide a system and method for a complex trading mechanism in which a participating trader's message space (that is, the set of admissible orders) includes complex orders. In simplified terms, the complex orders include conditions that are to be met when the trading mechanism clears and that can be verified only knowing the realization of orders submitted by other traders and/or the trade results in other than only the trade (quantities and prices) assigned to that trader.

For a complex order to execute, the complex conditions have to hold (that is, be met) at the clearing, meaning that the complex conditions are defined on the circumstances at the clearing. In more formal terms, the complex conditions are defined on the state of the world at the clearing. The term state of the world is commonly used in economics to refer to the uncertain outcome, event, or circumstances (of random variables that describes any measurable event; of characteristics of a market, such as its liquidity; of the weather; of the behavior of a collection of agents; etc) at a future date.

The choice as to which specific complex conditions traders are allowed to express in their complex orders depends on the message space chosen by the designer, as discussed in later sections.

For example, a complex order could be conditional on features of the trade results (i.e. allocation and transfers) across traders, specifying that the trader wants to buy a specific quantity of items in a multi-unit auction only if the total quantity sold is above some minimum, or the largest quantity held by any other winning trader is below some maximum. A complex order may also include conditions on statistics formed with other traders' winning and/or non-winning bids. This would allow traders to bid a certain amount for a given item only if there are at least a minimum number of other bids within a specific range of his bid, or to bid a specific price and quantity in a uniform price multiunit auction only if, on average, over the units he may win, the price of the last winning order were he not to participate in the auction would be lower by at most a specified amount (the latter example captures a price impact condition, which is discussed in more detail later).

The following discussion will begin with a description of the structure of the components of the present technology. The discussion will then be followed by a description of the components in operation.

### Structure

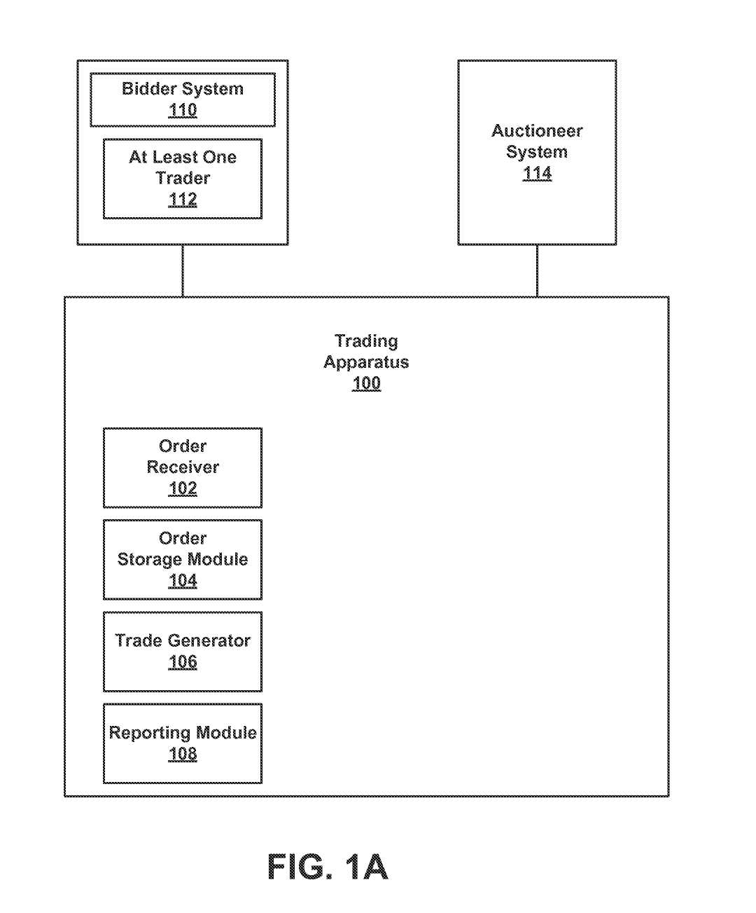

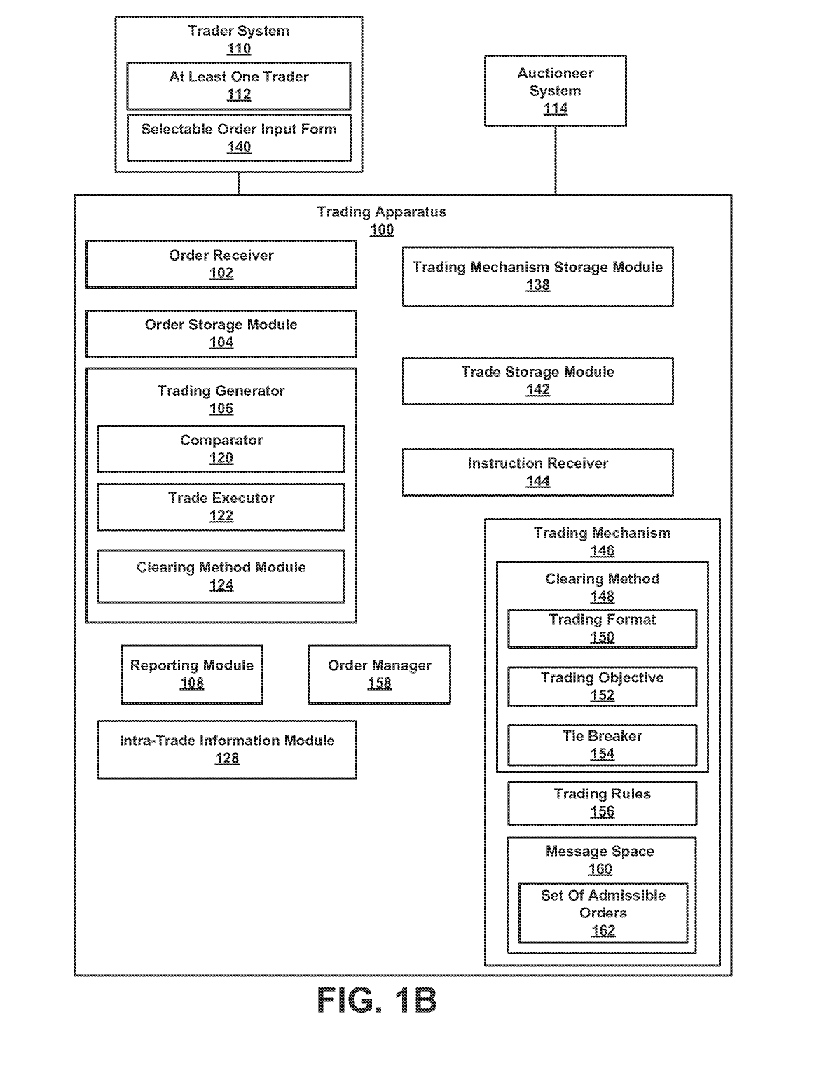

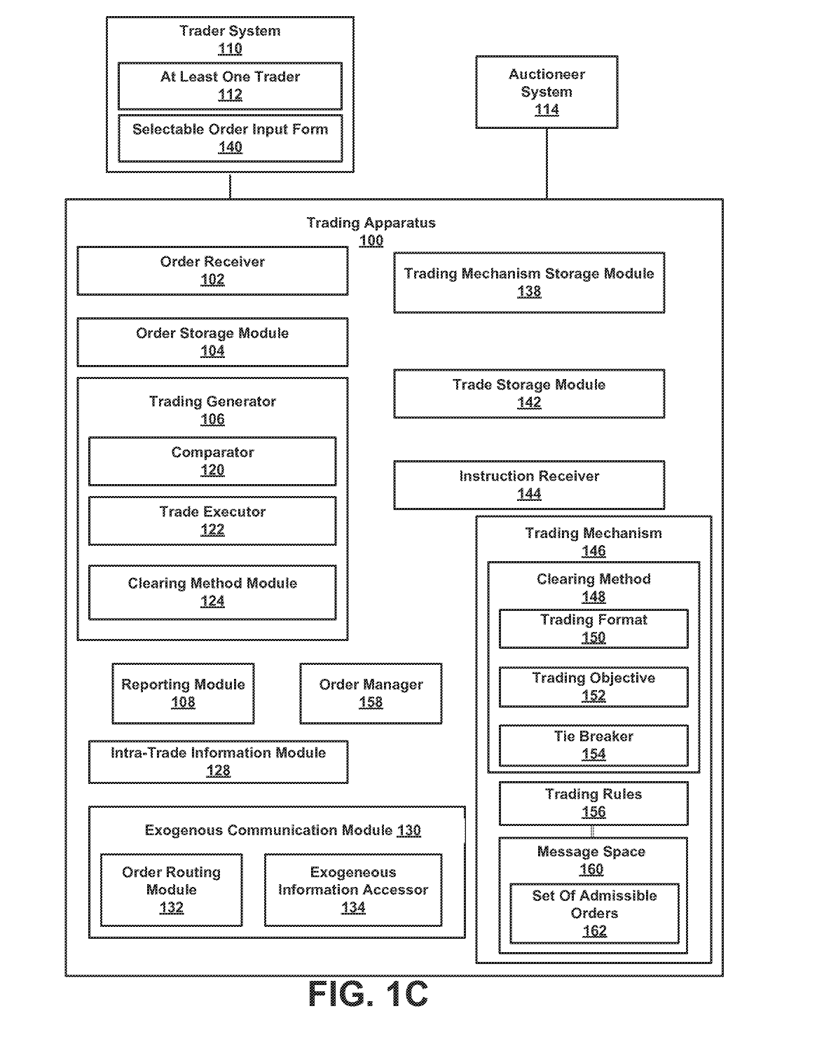

FIGS. 1A and 1B are each a block diagram of an example trading apparatus as it would be used in the simple setting described below, in accordance with an embodiment of the present technology. Referring now to FIG. 1A, the trading apparatus 100 in the present technology includes an order receiver 102, an order storage module 104, a trade generator 106 and a reporting module 108.

In one embodiment, the trading apparatus 100 is coupled via wire and/or wirelessly with an entity participating in an exchange and/or an auction. For example, but not limited to such example, the trading apparatus 100 may be internal or external to an auctioneer's system 114. Further, in one embodiment, the trading apparatus 100 is coupled with a bidder system 110, wired and/or wirelessly. In one embodiment, the bidder system 110 received bids from bidders. In one embodiment, the bidder system may also be called a trader system. In one embodiment, the bidder system 110 includes a selectable order input form 140, for being selected by the at least one trader 112. That is, the at least one trader may enter his orders using the selectable order input form.

In one embodiment, the order receiver 102 receives orders from at least one trader. The “orders” include at least one complex order. The order receiver 102, in one embodiment, receives at least one complex order having a condition selected from the group of condition categories consisting of: items bought; items sold; the auction allocation and transfers; statistics derived from information contained in the orders; variables whose calculation requires utilizing at least some information included in the orders; item-less trades; features of orders matched with the at least one complex order; and impact on intra-trade information. It should be noted that the group of condition categories listed above is non-exhaustive.

Moreover, the order receiver 102, in another embodiment, receives at least one complex order having a condition on a variable that captures a concept in the group of concepts consisting of: price impact of an order; auction depth; market depth; liquidity; oversubscription; level of competition; equity; dispersion; supply-demand-imbalance; stability; and momentum.

The order storage module 104 stores the orders, in one embodiment. In one embodiment, the order storage module 104 stores information such as, but not limited to: items in the auction, traders' identities, the traders' passwords, the traders' bids (including both the set of submitted orders, as well as the set of valid, outstanding orders).

Referring now to FIGS. 1A and 1B, in one embodiment, the trade generator 106 generates trades based on the (submitted) orders and a trading mechanism 146. In one embodiment, the trade generator 106 includes a comparator 120 and a trade executor 122. The comparator 120 compares stored orders with a trading mechanism 146, while the trade executor 122 executes the trades based on the comparing of the comparator 120. In another embodiment, the trade generator 106 includes a clearing method module 124 that executes a clearing method 148 (of trading mechanism 146, to be below).

In one embodiment, the reporting module 108 reports the trades. Example items that may be traded are, but are not limited to the following: public sector bonds, private sector bonds; bills; notes; stocks; exchange traded funds; derivatives; options; credit default swaps, variance swaps; commodities; power; oil drilling rights; emission allowances; emission credits; real estate; online advertising spots; patents; spectrum licenses; airport landing spots; data capacity; other tangible goods; and other intangible goods.

In various further embodiments, the trading apparatus 100 includes one or more of the following: order manager 158; intra-auction information module 128; trading mechanism storage module 138; trade storage module 142; instruction receiver 144; and trading mechanism 146.

In one embodiment, the order manager 158 manages an event associated with the orders. In one embodiment, the order manager 158 is for managing an event associated with the orders selected from the group consisting of: submission of the orders; amendment of the orders; cancelling of the orders; generating a set of valid outstanding orders from the orders; confirming a receipt of the orders; publishing of a portion of the orders; and a trade generated based on the orders. However, it should be understood that the group of events is not exhaustive.

Referring still to FIGS. 1A and 1B, in one embodiment, the trading apparatus 100 includes an intra-trade information module 128. The intra-trade information module 128 reports and generates intra-trade information based on the orders and/or trades, and based on the trading mechanism 146.

Referring still to FIGS. 1A and 1B, in one embodiment, the trading apparatus 100 includes a trading mechanism storage module 138. The trading mechanism storage module 138 stores information about trading mechanisms 146. In one embodiment, the trading mechanism storage module 138 is accessible by the trading generator 106.

In one embodiment, the bidder system 110 (which may also be called a trader system) includes a selectable order input form 140 for being selected by the at least one trader 112. Further, in one embodiment, the selectable order input form is selected from the group of selectable order input forms consisting of: a sentence specifier; a mathematical condition specifier; a function specifier; a range specifier; and a trade objective of the at least one trader 112. However, it should be understood that the group of selectable order input forms is not exhaustive.

Further, formulations are selectable via a selectable order input form that may include but are not limited to the following: selection among a finite set of options, specification of sentences, specification of mathematical conditions, functions, or ranges.

Further, and as will be discussed in depth in the Operation section below, these non-complex conditions may be, but are not limited to the following: pegging conditions; routing conditions; trade-inspired conditions; a minimum execution size; and a bundle condition. In another embodiment, each of the at least one complex order includes: at least one complex condition and at least one condition that is non-complex selected from the group consisting of: pegging conditions; routing conditions; trade-inspired conditions; a minimum execution size; and a bundle condition.

In one embodiment, the trading mechanism storage module 138 stores information about the trading mechanism 146 to be used for running the auction and any intra-trade information. For example, the trading mechanism in 146 may be parameterized, such as is the case for some the examples in the section titled Rules Around the Clearing show. As a very simple example, the trading mechanism may specify running a double auction periodically, at specific time intervals t (i.e. the trading mechanism may be parameterized by the length of the interval, t_int). The trading mechanism storage module 138 may store the value of t_int (which may for example equal 5 minutes, or 1 hour). Storing this value separately as opposed to inside the trading mechanism 146 may be useful in some embodiments, as it could, for example, allow a designer to make changes to the mechanism very easily. The trading mechanism storage module may also store intra-trade information, such as for example the length of time since the last auction, or the volume crossed in the last auction. For example, a trading mechanism in 146 may be parameterized both by t_int and the volume crossed in the last auction in the following way: run the double auction periodically every time interval t_int, unless the last auction crossed more than some number N of items, in which case the double auction is run twice as frequently. Again, in this example, storing the information about t_int and the last volume crossed can be useful as it may make it easier for a designer to quickly make changes to the overall trading mechanism.

In one embodiment, the trading apparatus 100 includes a trade storage module 142. The trade storage module 142 stores information associated with the trades. For example but not limited to such example, the trade storage module may store auction allocation and quantity or any additional information that is derived by the trading generator 106 that clears the auction by taking in the relevant information from the trading mechanism 146.

In one embodiment, the trading apparatus 100 includes an instruction receiver 144. The instruction receiver 144 receives trade reporting instructions.

In one embodiment, the trading apparatus 100 operates in at least one round of a dynamic auction. In one embodiment, the trading mechanism 126 includes a clearing method 148. In yet one embodiment, the trading mechanism 146 includes at least one trading rule 156. In one embodiment, the at least one trading rule 156 associated with said trading mechanism is selected from the group consisting of: rules regarding orders; rules regarding monetization; rules regarding a candidate set of items; and rules regarding when to clear a trade. It should be appreciated that the immediate foregoing group is non-exhausting. Further, in one embodiment, the at least one trading rule associated with the trading mechanism may be one of, but not limited to, the following: parameters for specifying admissible conditions of said at least one complex order; parameters for specifying admissible conditions for said non-complex orders; parameters for amending said orders; parameters for cancelling said orders; parameters for publishing a portion of said orders; parameters for specifying timing requirements for submission of said orders; a candidate set of trade items to be traded; a number of participating traders and an identification of said participating traders; a required trading deposit; parameters for specifying an event causing said trade generator to compare said stored orders with said trading mechanism; parameters for specifying an event causing said trade generator to execute said trades; information associated with said trades that is to be communicated to said at least one trader after said trades are generated; communication rules with other trading venues; intra-trade information to be communicated to at least one said trader; parameters specifying communication of information about said trading mechanism to said traders; monetary transfers to occur per execution of said orders; monetary transfers to occur per execution of said orders based on at least one feature of said orders; monetary transfers occurring per execution based on at least one of information that arises when said trades are generated and information that is utilized to generate said trades; and budget balancing rules. Note that the trading rules associated with parameters for specifying admissible conditions of said at least one complex order and parameters for specifying admissible conditions for said non-complex order, refer to the set of admissible bids for the trading mechanism. The set of admissible bids is by definition part of the traders' message space for the given trading mechanism. For ease of exposition, in one embodiment, the trading mechanism 146 includes a message space 160 and in one embodiment, the message space includes the definition of a set of admissible bids 162.

In one embodiment, the clearing method 148 includes at least one of the following: a trading format 150, a trading objective 152 and a tiebreaker 154.

In another embodiment, the trading format 150 utilized by the trading apparatus 100 is selected from the group consisting of: a first price auction format; a second price auction format; a first price combinatorial auction format; a second price combinatorial auction format; a discriminatory price auction format; a uniform price auction format; a discriminatory price combinatorial auction format; a uniform price combinatorial auction format; and a combinatorial auction format. It should be understood, however, that the group of trading formats is non exhaustive.

In another embodiment, the optimization of the trading objective 152 involves the consideration of an effect of the generated trades on at least one criterion, the criterion selected from the group consisting of: auctioneer revenue; auctioneer cost; gains from trade; trade volume; maximizing auctioneer revenue; equity; dispersion; and price stability. It should be understood, however, that the group of criteria is non-exhaustive.

### Bids/Orders in a Simple Setting

Complex mechanisms allow traders to submit complex orders. In particular, complex mechanisms allow at least one trader i to submit at least one complex order. A complex order includes at least one complex condition that is to be met when the auction clears. That is, a complex condition is defined on a state of the world at the clearing/when the auction clears. Moreover, the set of admissible orders (including the subset of admissible complex orders) are defined as part of the message space for the trading mechanism.

A condition included in a bid by bidder i is to be called complex, if it has two of the following characteristics: (a) verifying the condition is not always possible knowing only (1) bidder i's allocation and transfers (Xᵢ, Tᵢ); and (2) bidder i's own bid information (where “not always” means that there exist constellations of bidders and bids submitted, for which verifying the condition is not possible knowing only said information in (a)), and (b) verifying the condition at least some times requires using at least some of the information contained in the auction allocation and transfers excluding bidder i (X-Xᵢ, T-Tᵢ), and/or some information that is contained in or derived from the entirety of auction bid information or parts thereof (where “At least sometimes” means that there exist constellations of bidders and bids submitted for which verifying the condition requires using at least some of said information in b).

The term state of the world is commonly used in economics to refer to uncertain outcomes, events, or circumstances at a future time or time period.

The following is a description of possible admissible bids in the simple setting, consistent with embodiments of the technology, starting out with five categories of complex conditions (which correspond to five categories of complex bids). Each of the five categories of complex conditions, allows bidders to submit bids conditional on certain aspects/features of a state of the world at the clearing.

Of note, more categories of complex conditions may exist in the simple setting. This description of five categories is not mutually exclusive or exhaustive. In particular, since the categories are not mutually exclusive, other categories may be defined for example by combining subcategories that exist within the five categories below.

In a number of embodiments consistent with the technology, bids belonging to the five complex bid categories described below not only satisfy the constraints a) and b), but satisfy stricter constraints, as explained next.

For ease of exposition, let W denote the information in a) and Z denote the information listed in b). [That is, W denote the bidder i's allocation and transfers (Xᵢ, Tᵢ); and the bidder i's own bid information. And Z denotes the information contained in the auction allocation and transfers excluding bidder i (X-Xᵢ, T-Tᵢ), and/or some information that is contained in or derived from the entirety of auction bid information or parts there of].

First, the bids belonging to the five bid categories satisfy a). Next, these bids satisfy that for at least one particular constellations from a) the complex condition can be verified knowing (X, T) and the entirety of auction information. That is, knowing (X, T) and the entirety of auction information is sufficient to verify the condition for that particular constellation. Now, since by construction, for that particular constellation it is not possible to verify the condition knowing only (Xᵢ, Tᵢ) (and the bidder i's bid information), knowing the information in (X-Xᵢ, T-Tᵢ) and/or some information contained in or derived from the entirety of auction bid information or parts there of must have been required (since there is no additional information available in the simple setting that this trading mechanism operates in.).

An equivalent formulation to state the “not always possible” constraint in a) which states that there exist constellations of bidder and bids submitted, for which verifying the condition is not possible, is as follows: there exists at least one set of bids in the set of admissible bids, for which verifying the condition is not possible. An equivalent way of formulating “verifying a condition is” is “determining whether the condition is met”. Moreover, as stated earlier, the terminology for auctions and trading mechanisms is used interchangeably, so auction terminology (bid, bidder, etc) is understood to also hold for trading terminology (order, trader, etc.) and vice versa, unless explicitly stated. Also note that verifying with more information than

For the simple setting, the following is thus consistent with embodiments of the technology (and further illustrated with the help of the five complex condition categories described next).

A trading apparatus having a trading mechanism including a message space that defines admissible orders, said trading apparatus comprising: an order receiver for receiving admissible orders from at least one trader i, said orders comprising at least one admissible complex order submitted by said trader i, said complex order including at least one complex condition defined on a state of the world at a clearing, wherein given said trading mechanism: for at least one set of orders in the set of admissible orders from traders other than trader i, determining whether said complex condition is met is not possible knowing only the information contained in the group of trader i's allocation and transfers in said clearing, trader i's own order information, but is possible knowing the information contained in the group of the trade allocation and transfers in said clearing, and the entirety of order information; an order storage module for storing said admissible submitted orders; a trade generator for generating trades based on said admissible submitted orders and said trading mechanism; and a reporting module for reporting said trades.

A list of five complex bid category follows now. As will be explained in more detail further below, a bid may include any combination of complex conditions (whether they belong to the same or different categories, or do not belong to any of the five categories listed below), as well as any non-complex conditions.

The first category of complex conditions are conditions on the set of items sold and/or bought in the auction. These conditions matter, for example, if only a candidate set of goods to be bought or sold is known ex-ante. If so, a) above holds, because a bidder who, for example, won 100,000 shares in a stock auction cannot tell from that number how many shares were sold overall, and thus b) holds because said bidder would have to find out about information regarding the entire allocation in the auction (in this case, the total quantity sold). An example of a complex bid of the first category would be a bid in a double-auction, conditional on the total quantity exchanged (i.e. traded) being at least some amount (since that total quantity depends on the submitted bids to buy or sell and is thus unknown ex-ante), or a bid in a securities auction that included a condition on the total quantity sold or issued (as long as the total quantity was not fixed by the auctioneer ex-ante). Note that the bid may actually be a demand/supply function (as is common in the auction theory literature): as a simple example, he may state “I am willing to buy 10,000 shares at 30, and an additional 5,000 shares at 29.99”. (These bids are sometimes referred to as tiered bids in financial markets.) If the demand function was conditional on the total quantity traded, it may say “I am willing to buy 10,000 shares at 30, and an additional 5,000 shares at 29.99, as long as at least 50,000 shares in total are executed”, and the trader may submit a different demand function if the total quantity was less than 50,000 shares. Traders may submit bids that state that they do not want to be more than a set percentage of the total quantity (akin to participation constraints in algorithmic trading). Or, as another example, in an auction to liquidate a portfolio of stocks, bidders may make their bids for any of the stocks (or packages of stocks) conditional on the total amount sold of that stock or on the total sold across stocks.

Bids with complex conditions of the first category may be bids on single items Bids with complex conditions of the first category may be bids on multiple items. As an obvious example, a bid on a single item conditional on the set of items bought or sold may be “I want to buy 1 share for at most $X, if at least Y shares are issued”, a bid on multiple items may be “I want to buy 2 share for at most $X, if at least Y shares are issued”. Items in multiunit bids can of course be identical or non-identical (consistent with the definitions for items and multiple items in the Definitions section above).

The second category of complex conditions are conditions on the auction allocation and/or transfers excluding bidder i, other than on the set of items sold and/or bought. Complex conditions of the second category also include conditions on the allocation and/or transfers (that is, including bidder i).

An example of the second complex category would be as follows. In an auction for dissimilar goods, bidder i may bid $5 for good A, conditional on good B not being won by a specific other bidder j. This bid satisfies a) and b): if bidder i did not happen to bid on, and win good B along with good A, then for him, verifying whether bidder j won good B is not possible knowing only what item he won himself (the information in Xᵢ), but would be possible using the information in the allocation excluding himself, X-Xᵢ (which does specify who, other than bidder i himself, won good B). Notice that the terms “always” and “at least sometimes” are included in the conditions a) and b), because in the case in which bidder i have happened to also bid on, and win good B, he would indeed know that bidder j could not have won good B, and thus be able to verify his condition on good A (in this case, verify that the condition is met), based only on the knowledge of what he won, Xᵢ, and without knowledge of what other bidders won, X-Xᵢ, causing conditions a) and b) not to be met.

The following are examples of conditions on the allocation and/or transfers. That is, a bid in this category involves bidding on at least one item, while adding a complex condition on any features of the allocation and transfers (note that some of the following examples are discussed later on in more detail). Consider an underwriter trying to decide how much of two bonds A and B to issue. Bidders may be allowed to condition their bids on how much of A issues versus how much of B. As another example, in an auction used for underwriting of a bond or of an IPO for a stock, bidders may be allowed to condition their bids on the identities of the winners, such as what percentage was won by retail versus institutional investors. Bidders may condition their bids on the amount won by a specific bidder in an auction (this may be useful, for example in auctions in which a specific bidder has more information than others, as may be the case in the context for TARP securities, were former owners of the portfolio for sale may have more information than other bidders). Bidders may condition their bids on the number of different bidders, or on how much of the total was won by the N winners who won the most. Bidders may condition their bids on the average price of the winning bid for all items (for example, in a multi-unit auction for identical goods, like bonds), or on some subset of items (here, bidders in a real estate auction may say something like “I am willing to pay $X for this house, as long as the average of winning bids for some group G of houses on the same block is at least $Y”). Bidders may condition their bids on the identity of the other winning bidders, for example a trader may say “I am willing to buy up to 10,000 shares of this stock at price $X, only if sellers in the trade that I am part of consist at most of y % of traders in a specific group G”. Here, “trade that I am part of” means the larger overall trade that the bidder's order would be part of at execution.

Bids with complex conditions of the second category may be bids on single items. Bids with complex conditions of the second category may be bids on multiple items. In particular, these bids may be either conditional on the allocation and transfers, or on the allocation and transfers excluding bidder i.

The third category of complex conditions are conditions on statistics derived from information contained in the bid information excluding bidder i, (potentially using both winning and losing bids), where the statistics can be formed only knowing at least some information contained in the set of bids submitted. Also part of this category are bids conditional on statistics derived from information contained in the bid information (that is, all the bid information, including bidder i).

An example of a bid in the third category would be that of bidder i bidding on good A and including a condition stating that there must have been at least 3 bidders that submitted bids above $4 for good A. This bid cannot be verified knowing only (Xᵢ, Tᵢ), and can be verified using a simple statistic formed with information in the bid information excluding bidder i. As another example, consider underwriting or IPO applications, in which bidders are allowed to condition their bids on the level of oversubscription (this scenario is discussed in more detail later). The statistic that captures oversubscription may the number of bidders that participated in the underwriting, or the total amount demanded (for example above some reserve price). Any other term may be used for oversubscription, such as simply level of subscription or participation, or interest (or the less positive term of undersubscription). Bidders may also condition their bid on the level of oversubscription/participation by a specific group of bidders, for example differentiating between retail orders and institutional orders that were submitted. Or, for example, if not all bidders in an auction submit bids that include prices, bidders could condition their bids on some statistic reflecting the number of bids that did not have prices or the number of bids that had prices. Intuitively, bids without prices in an underwriting would be the equivalent of a market order in a continuous market, and bids with limits would map into limit orders. Bidders may also condition their bids on the number of bids without prices (market order type bids) submitted across different groups. Or bidders may condition their bid on the number of bids that were larger than a specific size (i.e., bids for quantities above some threshold q).

Note that bids in an IPO that do not include prices may have complex conditions: for example, a bidder may bid to buy 10,000 shares, conditional on at least some number N of shares being issued. In this example, the IPO price could, for example be set entirely by the bids which do contain prices (first option), or by calculating a price that reflects both the bids with prices and the bids without prices (second option). A simple way to do the first option could be as follows: set aside x % of the total shares N sold to be assigned to orders without prices, find a price by running a uniform price auction for a total of (1−0.x)*N shares for the bids that contain prices, choose the total N to be issued (all the while allowing both bids with prices and bids without prices, to condition on N as stated at the beginning of the example). As for the allocation, the most straightforward way would be for bidders who bid above the auction price to execute in full, and for those who bid at the auction price to be prorated, and for those who bid only a quantity to be prorated. (As an aside, note that a simple other kind of complex bid that could be allowed, would involve conditioning on the number M of participants in the IPO). A simple way to do the second option would be to find a price by running uniform price auction for a quantity N on the bids with prices, and then adjust the price upwards and the allocation upwards to N′, based on those bids that did not include a price (while determining the allocation among bidders following a rule involving the total number of bids with prices and bids without prices and while allowing the bidders to condition on the total issued, which is N′).

Bids with complex conditions of the third category may be bids on single items. Bids with complex conditions of the third category may be bids on multiple items.

The fourth category of complex conditions are conditions on variables that may only be calculated using at least some of the information in the bid information excluding bidder i.

An example of a bid of the fourth category would be as follows. Bidder j above, participating in a uniform price auction for a stock, may state that he would be willing to buy up to 1,000 shares at a price of up to $7, conditional on the price impact of the shares won being at most, say, 0.0001$ per share on average (alternatively, he may put the limit of 0.0001$ on each individual share bought). Here, the variable bidder j conditions his bid on is the price impact of his bid (which is related to the liquidity or depth of the auction). The in operation section of this document illustrates how price impact can be calculated, and how different versions of constraints capturing price impact may look like. The basic idea behind these kinds of constraints, though, is to capture how much bidder i winning the shares moves the price at which the auction clears, compared to if he had not participated. The bid falls in the third category above, because calculating this price impact, requires to use bids in the set of auction bids excluding bidder i (both bids that ended up being winning bids, and bids that were losing bids in the auction).

Other than price impact, bidder may condition on variables such as, but not limited to, auction depth, market depth, supply-demand imbalance (whether there are much more buyers than sellers, for example), oversubscription, competition, liquidity, dispersion of the auction allocation (that is, whether in a multi-unit auction, a few bidders win a large fraction of the total of goods, or whether there are many “small” winners), or equity (capturing whether, for example, one specific group of bidders wins many items, the difference to dispersion being that the identity of the winners matters). The specific definition of these variables, and the choice as which, if any, conditions on these variables bidders are allowed to submit, is left to the auction (or mechanism) designer. That is, the designer chooses how to capture a given concepts in a statistic, deciding how the statistic is calculated for given sets of orders that were submitted. For a given concepts, there are multiple ways to capture it, and the designer decides which specific ones are more intuitive and appropriate for a given application.

Bids with complex conditions of the fourth category may be bids on single items. Bids with complex conditions of the fourth category may be bids on multiple items.

Also consistent with the invention are complex bids of a fifth category. These bids are item-less complex bids: they may include conditions of categories one through four, but differ from any of these categories, because the bidder bids a transfer (or amount) based on the conditions holding, without bidding on any auction items. For example, bidder k in the first example above may bid to pay $1 if item C is not won by a specific bidder h (which would be similar to a complex bid of category two, but is still different because the condition is not attached to a bid for, say, item A). Complex bids of the fifth category may be especially useful in auction-like settings, where the present technology is used to coordinate decisions.

Within the fifth category, it one can distinguish bids that are item-less with conditions on the allocation and transfers. Bids with complex conditions of the fifth category may be bids on single items. Bids with complex conditions of the fifth category may be bids on multiple items.

In some embodiments of auctions of the present technology, bidders may submit bids that include more than one complex condition. In particular, bidders can combine conditions that are of the same category described above, and/or of different categories. Thus, a bidder in a securities auction may say that he would like to buy up to 1,000 shares of a stock for a per share price of up to $70, but only if the price impact per share was at most $0.0001, and the total quantity issued was above a certain amount. A bidder's bids, complex or not, may also include a condition that is standard in auctions, such as a minimum execution size. That is, bidder j in the previous example, may add the condition that he would like to buy at least 600 shares in the auction. In some embodiments, complex bids may also be combined with other contingent bids in the prior art. For example, bidder i may include conditions on the set Xᵢ that he wins, stating that he would like to buy A and B only as a bundle, and only if a specific other bidder does not win good C. Or for example he may say that he is interested in buying A and B as a bundle in an auction for underwriting of a bond (say one fixed rate issue, one floating rate), if at least a minimum of A and some minimum of B is issued, or if the total issued between A and B is above some threshold, or only if he buys at most a certain fraction of the total across issues. Bundle bids are also sometimes referred to as basket bids in financial markets, and as combinatorial bids in the combinatorial auction literature.

A bidder in some embodiments of the present technology may submit multiple complex bids (which may each have multiple complex conditions). Also note again, that a complex bid will refer to a bid that includes at least one complex condition (but may include more than one complex condition as well as any number of conditions that exist in the prior art).

The designer is the one defining the trading mechanisms, and following sections describe at length about the choices he may make, in particular with respect to the clearing method. At this point, it is useful to make a few high-level comments about the way in which allocation and transfers are generated.

In some embodiments, the prices corresponding to the allocation and transfers are generated endogenously, without the use of randomization. In contrast, in some embodiments, randomizations may be involved in finding a price. Consider the following example involving randomization to generate prices. Rather than running a standard double auction for a stock, a designer may choose to generate a random number p in some interval [p1,p2], set the price in the mechanism equal to p. At the same time, bidders in this example may have been allowed to submit bids conditional on features of the allocation (such as stating that they only want to be part of trades that are above some threshold that they choose, or that they want to be at most a certain fraction of the total traded). Given the price p, the designer may then choose the allocation that maximizes volume, while satisfying all the bidder constraints. Moreover he may decide that for any given total volume Q, he may give priority to orders that had more aggressive prices (so if two buyers bid above p, the one with the higher price would get priority), or he may decide to give the same priority to any buyer with a bid above p and seller with a bid below p. Note that these choices are similar to whether orders receive price priority in auctions (with proration only at the margin), or whether orders are prorated. If the designer was operating as part of a richer setting, which is discussed later, he may adjust the design accordingly and for example give priority to orders that were submitted earlier (commonly referred to as time priority).

In some embodiments of the present technology, the complex bids described can be submitted as bids that are valid for a given round in any dynamic auction in the prior art. Such dynamic auctions include, but are not limited to, auctions in which in at least one round, bids for the current and/or future rounds can be manually and/or automatically adjusted or entered. The present auctions could, for example, be run in one or more of the rounds, and the result (or information derived from the result) may be communicated to the bidders in that round, without having the allocation and transfer be implemented (in that goods are bought or sold) until the final round of the superseding dynamic auction. (The terms result, or trade result, means the allocation and transfer.)

In some embodiments, the set of admissible bids (i.e. the set of bids bidders are allowed to submit) may consist of complex bids and other bids common in the prior art, these other bids having no conditions and/or one or more non-complex condition.

### Bids/Orders in a Richer Setting

FIG. 1C is a block diagram of an example trading apparatus as it would be used in the richer setting described below, in accordance with an embodiment of the present technology.

In one embodiment, the trading apparatus 100 includes an exogenous communication module 130. The exogenous communication module 130 communicates with an exogenous trading venue and/or a data feed. The exogenous trading venue is a trading venue other than the trading venue including the trading apparatus 100.

In one embodiment, the exogenous communication module 130 includes an order routing module 132 and/or an exogenous information accessor 134. The order routing module 132 sends a portion of the orders to the exogenous trading venue. It should be understood that a portion may refer to a part less than a whole of the orders, or the entirety of the orders. In one embodiment, the order routing module 132 receives orders from exogenous venues. The exogenous information accessor 134 accesses information from the exogenous trading venue and/or a data feed. In one embodiment, the exogenous information accessor 134 sends information to exogenous trading venues and/or sends out data feeds.

Embodiments of the invention in the richer setting may allow bidders to submit a number of additional bid types, compared to the simple setting. These bid types include pegged, routed, and trading-inspired bids, which are described next, followed by a detailed description of how the complex bids from the simple setting carry over to, and are augmented, in the richer setting.

First, it is useful to introduce a concept from trading, namely that of pegging orders. Pegging of orders offers advantages in continuous markets that move fast (for example in the US equities market, where sub second execution speed and high frequency trading strategies are common). Specifically, a trader may submit an order that is pegged to a variable such the best bid for a stock (or the ask, or the midpoint), by stating that he wishes to buy a specific quantity of the stock for a price that is equal to the current midpoint minus a number of cents (or tick sizes). The price of a pegged order would thus continuously adjust to the variable that the order is pegged to, without requiring continuous monitoring from a trader (who may otherwise have to submit and cancel orders continuously to replicate the pegged order, and would likely miss out if markets were to move quickly). A more general version of pegging is introduced next, as a feature of the present technology.

In some embodiments of the present technology, bidders may submit pegged bids, which include conditions (much like complex bids do), and for which it is useful to distinguish categories, which vary by the conditions that the pegged bids include.

The first category of pegged bids include conditions on the time at which the auction clears. For example, if an auction of the present technology was run for a specific NYSE listed stock, a bidder may condition a bid of $30 for 10,000 shares on the time at which the auction clears, specifying that he would like to buy only as long as the auction clears within the next five minutes, or by 3 pm. Or, the bidder may specify that a bid for a given price and quantity be cancelled after 4 pm.

A second category of pegged bids include a condition on at least one exogenous variable, by conditioning on said variable's realization at the moment that the auction clears. A bidder may condition his bid on the current midpoint of the NBBO for the stock at the time of clearing, or on said midpoint being in a specific interval, or on the realized volatility of the stock over the last 3 min up until the moment of clearing, or on statistics formed with any other exogenous variable, such as the price of a specific call option, or the volume of outstanding best bids for that call option at the time of clearing.

An example of a bid with conditions from category one and two above would be that of a bidder specifying a to buy a good as long as the midpoint of a specific stock (or some other exogenous variable) has not moved outside of a given interval before 3 pm.

The third category of pegged bids include conditions on the intra-auction information sent out by the auctioneer. For example, if the intra-auction messages sent out by the auctioneer includes a likely price range applicable to an order of a fixed size, the bidder may submit a bid to buy a specific quantity of the stock conditional on said price range being within an interval that he specifies. Or, if the intra-auction information includes information about the number of bids, or the total volume of bids submitted in the last 3 min, a bidder may include a condition about said number or volume being above a threshold.

In some embodiments of the present technology, bidders may include in their bids combinations of conditions on exogenous variables and/or combinations of these and other conditions as described in the complex bids so far. In one embodiment, these combinations of conditions on the exogenous variables and the combination of these other conditions include at least one complex condition.

In embodiments of the present technology, bidders are allowed to submit routed bids, that is, bids for which at least a part of the bid may be, or has to be, routed out to other (exogenous) trading venues for execution. For example, a bidder in the auction may submit a bid for 100,000 shares of a stock for up to 5$, as long as the price impact of the bid is at most a certain amount, and with a routed part of the bid specifying that he wishes to send a limit order (or market order) to a specific exchange or collection of trading venues (likely through the use of an order routing system), to buy some number of shares of another stock for every share of the stock he wins in the auction.

Also consistent with the present auction formats are trading-inspired bids, namely bids that are the a) natural analogue to order types that exist in the prior art for trading mechanisms (in that they are submitted to exchanges or other trading venues) and that b) do not simply consist of a price and quantity (but instead, include some other specification). What is meant by natural analogue is that the defining feature of the order translates to the bid. That is for this specific kind of trading inspired bid, a distinction is explicitly made between auctions and trading mechanism. For example, an immediate-or-cancel order is sent to venues, and is immediately cancelled if no execution occurs. The bid analogue would be a bid that is immediately cancelled if it does not immediately enter and subsequently win in the clearing of the auction. In some embodiments of the present technology, bidders may thus submit bids that are analogues to good-till-cancel/crossing orders, stop orders, and other standard orders that satisfy a) and b) above. The bidders may specify that their bid expires depending on other variables (for example depending of the value of the NBBO midpoint for some stock), and the bidders may specify a visible and a hidden part (much like is the case for reserve orders), and include complex conditions to the hidden part of the bid.

In the richer setting, complex bids can be augmented compared to their definition in the simple setting. In particular, consider a bid submitted at time t′ by bidder i bidding in an auction, said bid with a condition to be satisfied if and when it clears in an auction whose clearing process starts at time t (and is thus based on the valid, outstanding bids at time t) and generates an auction allocation and transfers (X, T) (where (Xᵢ, Tᵢ) refer to the allocation and transfers of bidder i). Here, it is assumed that the clearing process is virtually instant (be it for the purpose of the application), as is common practice in design. The section on trading rules does include a few comments about straightforward ways to accounting for physical running time in practice (that is, if a clearing process starts that starts at t does not finish until some time t+D later, where D>0). A condition included in said bid is to be called complex, if it has two of the following characteristics: (a) verifying the condition is not always possible knowing only: 1. bidder i's allocation and transfers (Xᵢ, Tᵢ); 2. bidder i's own bid history; 3. the time t; 4. the history of exogenous variables until time t; 5. the history of trades up until t, minus the information about the allocation and transfers (X.T) (that is, the history of trades up until t., meaning until just before time t); and 6. the history of intra-auction information for bidder i until time t, minus the information about the allocation and transfers (X, T) (where “not always” means that there exists constellations of bidders and bids submitted, for which verifying the condition is not possible knowing only said information in a)), and (b) verifying the condition requires at least sometimes using at least some of the information contained in the auction allocation and transfers excluding bidder i (X-Xᵢ, T-Tᵢ) for said auction, and/or some information that is contained in or derived from the entirety of auction information up until time t, or parts thereof (where “at least sometimes” means that there exist constellations of bidders and bids submitted for which verifying the condition requires using at least some of said information in b)).

The conditions (a) and (b) mimic the analogous conditions in the simple case, but differ slightly. In simple words, complex bids allow bidder i to condition his bid on something that he would not be able to find out based solely on the information available to him in the trading mechanism. In fact, Above, 1. and 2. are almost exactly as in the simple setting, except bidder i now has an entire history of bids that he submitted, as opposed to one valid outstanding bid. Note that formally, the simple setting is a subset of the richer setting. Thus, the description still formally applies for the simple setting: the time of the clearing would simply be fixed and the histories would simply collapse, consistent with the mathematical interpretation of the word histories (i.e. the history of bids would collapse to the bidder's bid in the simple setting, the history of exogenous variables would be empty, and the history of intra-auction information for bidder i would be empty as well).

The information about the clearing time t, 3, and the exogenous variable, 4, are included in (a) because otherwise, bids pegged on the clearing time or the time t value or time t history of the exogenous variable would be considered complex, which is not intended. Similarly, the history of trades up until time t_is included, because otherwise, algorithmic trading strategies, were bidders submit bids depending on histories of trades, would be considered complex bids, which is also not intended. Note that these bids would not be pegged bids, because the trade at time t is explicitly excluded. The reason for excluding the trade information at time t is that it includes the entire allocation and transfers (X, T), and thus in particular includes (X-Xᵢ, T-Tᵢ) (if the clearing process is virtually instant). Finally, the intra-auction information is included in 5, because otherwise, orders pegged to the auction information or algorithmic orders as above based on the intra-auction information would be complex, which is not intended. Moreover, it is necessary to subtract the information about the allocation and transfers at time t, (X, T), since the general setup for the mechanism does not prevent the trade information (X, T) sent at time t from being included in the intra-auction for bidder i information at time t (and it would be possible for (X, T) to be included in practice, if the clearing process was virtually instant, for the purpose of the application).

The first general comment about the definition of complex bids is that whether a bid is complex depends on the specific mechanism chosen, and, more precisely, on the history of intra-auction information available to bidder i at time t. Consider the case in which bidder i bids $5 per share for a lot of 10,000 shares, but only as long as there are at least 3 other bids for a lot of 10,000 priced above $4.5. If only sealed bids were admissible in the auction, the bid would be complex. If all submitted bids were immediately published, then the bid would not be complex, because the history of intra-auction messages up until time t available to bidder i would include information about all submitted bids, allowing to verify bidder i's condition. Note that if bidders had the choice between publishing and not publishing their bids, then the above bid would also be complex, because constellations of bidders and bids would exist, for which a) would hold (namely whenever at most 2 bidders bidding on a 10,000 lot at a price of above $4.5 chose to publish their bids).

As in the simple setting, a description of possible admissible complex bid categories follows. Five of these categories are the analogue of the respective category in the simple setting, with the exception of two additional categories. Also like in the simple setting, the categories are not mutually exclusive and not collectively exhaustive.

Moreover the seven complex bids belonging to the following categories satisfy conditions that are more restrictive than a) and b) above, just like the five categories in the simple setting. First, the bids belonging to the seven bid categories satisfy a). Next, these bids satisfy that for at least one particular constellations from a) the complex condition can be verified knowing (X, T) and the entirety of trading mechanism information. That is, knowing (X, T) and the entirety of trading mechanism information is sufficient to verify the condition for that particular constellation. Now, since by construction, for that particular constellation it is not possible to verify the condition knowing only (Xᵢ, Tᵢ) (and the information in items 2-6), knowing the information in (X-Xᵢ, T-Tᵢ) and/or some information contained in or derived from the entirety of trading mechanism information or parts there of must have been required to verify the condition (since there is no additional information available for the richer setting that this trading mechanism operates in.).

Following the same formulations as in the corresponding place in the discussion of the simple setting, for the richer setting, the following is thus consistent with embodiments of the technology (and further illustrated with the help of the seven complex condition categories described next).

A trading apparatus having a trading mechanism including a message space that defines admissible orders, said trading apparatus an order receiver for receiving admissible orders from at least one trader i, said orders comprising at least one admissible complex order submitted by said trader i, said complex order including at least one complex condition defined on a state of the world at a clearing; wherein, given said trading mechanism: for at least one set of orders in the set of admissible orders from traders other than trader i, determining whether said complex condition is met is not possible knowing only the information contained in the group of trader i's allocation and transfers in said clearing, trader i's own order history up until the time of said clearing, the time of said clearing, the history of exogenous variables up until the time of said clearing, the history of trades up until the start of the clearing, and the history of intra-auction information for bidder i until the time of the clearing; but is possible knowing the information contained in the group of the trade allocation and transfers in said clearing, and the entirety of trading mechanism information up until the time of said clearing; an order storage module for storing said admissible submitted orders; a trade generator for generating trades based on said admissible submitted orders and said trading mechanism; and a reporting module for reporting said trades.

Note that above, can also be grouped and labeled other information available to trader i in said trading mechanism up until the time of said clearing.

As mentioned, the complex bid categories from the simple setting carry over. This is obvious for the first and second category (which are defined by conditions on the items sold or bought, and the allocation and transfers, respectively). That is, bidders in the richer setting can still submit bids that are conditional on the allocation and transfers. Moreover, they can combine those complex conditions with other conditions: for example, a bidder may bid on N shares at a price of Y, only if at least Q shares execute in total (i.e. if the volume in the allocation is at least Q), and only if the volatility of the stock was at most Z in the previous minute.

The third category of complex bids (conditioning on information contained in bids other than bidder i's bid, or on information contained in all bids including bidder i), would now allow bidders to, for example, submit a bid stating that they would like to bid $50 for a stock, if there was at least some volume of bids submitted at a price of 49$ in the last 3 minutes. Notice that this example takes into account the bidding history of other bidders, as opposed to just the number of outstanding bids (as in the example given for the simple case, were a $5 bid on good A is conditioned on there being at least three bids above $4.5 for good A).

The fourth category of complex bids would also allow for more freedom in the richer setting, compared to the simple setting. A bidder could, for example, submit a bid for some number of shares conditional not just on the price impact that this bid would have, but conditional on what the change in the price impact is, compared to what the bid's price impact would have been, say, at its maximum or minimum in the last 5 minutes (of it had executed as part of whatever trades happened in those last 5 min, for example). Again, this example takes into account histories.

The fifth category, which is a bid with a condition as in any of the categories one through four, but without bidding on an item directly (as described in the simple setting), also naturally carries over to the richer setting (just as all the other four bids categories from the simple setting).

In the richer setting, it is useful to describe two more categories of complex bids. Notice though, that with or without these additional categories, the collection of categories described is neither exclusive, nor exhaustive (much like is the case in the simple setting). Also note that in the richer setting, bidders may condition on all the variables already described in the simple setting, and have more flexibility in doing that due to the added time component. The added time component also allows bidders to condition on variables such as stability and momentum. Stability here refers to the likelihood of large price changes: for example, a bidder could condition his bid on there being many bids submitted for lower prices, conditional on lower quantities. (If the number of said bids was high, a price drop or drop in liquidity would be more likely). As an example, a bidder may submit a bid conditional on the total quantity traded being at most Q and on there being at least N number of bids for some “low” price P conditional on the quantity being below Q. The price P would be considered low compared to whatever the current market price was (for example, P may be 80% of the current market price). Momentum could be captured with bids that condition on the number of bids submitted in the last 3 minutes (which have not yet executed) with prices higher or lower than the current price.

In some embodiments of the present technology, bidders may submit complex bids of a sixth category, which include a condition on information about those bids that the bidder is matched with in the clearing process. For example, a bidder in a double-auction may specify that he would like to buy a certain good at a specific price only if the bid of the bidder that he buys from was submitted within a specific time interval (for example, at least 5 seconds before the auction cleared). Or, a bidder may include a condition on his place in the queue: specifying, for example, that he would like to buy a number of units at a given price only if he is not the last bidder who buys units at that price (where bids with the same price are organized by time priority, which means that older bids have priority over bids at the same price that were submitted at a later time). Alternatively, a bidder may condition his bid on the identity of the other buyers that win the good, or on the length of time since when the other winning bids to buy the item have been submitted. Another example would be bidders in a double auction conditioning their bid to buy on the identities of the bidders on the opposing side of the overall allocation or on the identities of the overall set of bidders in the allocation). For example, bidders may bid conditional on the composition of the overall set of bidders by distinguishing retail investors, hedge funds, pension funds, and banks, etc.

In some embodiments of the present technology, bidders may submit complex bids of a seventh category, which includes a condition on the bid's effect on a variable in the intra-auction message if the bid were to be included in the set of valid outstanding bids, and said variable were to be updated accordingly. Note that whether this bid is complex depends, of course, on the intra-auction information available to the bidder. Also, this kind of bid has features of pegging. Finally, the bid condition may be met long before the bid executes at the clearing of the auction. In practice, it will likely be best not to let the bidder know when the condition has been met, as to avoid gaming by bidders. Another way to restrict abuse of such a bid may be to specify that this category of bids may not be canceled for at least some amount of time (for example, 3 seconds) after submission.

An example for bids in the seventh category would be as follows. If the intra-auction message consist of the likely range of prices applicable to a fixed-size order, a bidder may include the condition that the effect his bid would have on that price range may not exceed some amount per share (or some amount for the entirety of the order). Note that this example is intuitively similar to a bidder conditioning on the price impact of his order. The bid is complex, because at the time the bid clears (which may be long after the condition became true), the bidder cannot verify the condition knowing only his allocation and transfers, the time and the other information available to him in the trading mechanism, but can verify the condition knowing the entirety of auction information.

Complex bids of the seventh category may allow to run auctions that are less computationally intensive, since these kinds of conditions may be easier to calculate, compared to the calculations involved with complex bids of the fourth category that have a price impact condition, for example.

Finally, note again, that all aspects of the invention described in the simple setting are included in the richer setting. Moreover, any of the auction mechanism features and bid features can be combined. Thus, in particular, bidders may submit multiple complex bids (which may each have multiple complex conditions), and where a complex bid will refer to a bid that includes at least one complex condition but may include more than one complex condition, as well as any number of conditions that exist in the prior art. Bidders may also submit bids that include any subset of non-complex conditions described in this chapter (meaning that a bidder may have a pegged bid that is routed and/or has other trading-inspired conditions). A single auction in the present technology may be run as, or in, at least one individual round of a dynamic auction (as mentioned in the context of the simple setting).

Just like for the simple setting, in the richer setting, bids with complex conditions of categories 1-4, and 6-7 may be bids on single items or on multiple items. Any of these bids and any combination of these bids are consistent with embodiments of this technology.

On note, the choice as to which kind of the complex bids described may be submitted (for both the richer setting and the simple setting), and the way in which the complex bids (that is, the complex conditions) are formulated, is decided by the auction designer. Formulations may include, but are not limited to: selecting among a finite set of options, specifying sentences, specifying mathematical conditions, functions, or ranges. The designer decides which complex bids bidders may submit, and those bids are then called the set of admissible complex bids, which are part of the set of admissible bids, which are part of the traders message space. Note that the choice of the set of admissible bids (both complex bids and non-complex bids) is very important, as is discussed later. A designer in a multiunit auction for identical goods may for example choose that bidders are allowed to submit bids conditional on quantity, he then may decide what specific bids on quantity: for example, that the quantity has to be above a threshold, or that the participation of the trader be at most some fraction of the total quantity, or that the quantity be in a specific range). Then he could decide that the threshold for example, can only be expressed in lots of 1,000, and that for the participation limit only multiples of 5% are allowed, or that the range has to be chosen among three predefined intervals I₁, I₂ and I₃. Moreover, the designer may choose to allow a given kind of condition only on some subset of orders (for example, on orders of a specific size, or on orders that are priced aggressively, etc), and he may choose what kind of complex conditions could be combined, as well as what non-complex conditions (such as minimum sizes) may be combined with any complex conditions. These examples are to illustrate that the burden of the choice of what it is that traders are allowed to express lies with the designer, and that this choice is an integral part of the overall design of the mechanism.

The following describes different ways of price discovery that are consistent with embodiments of the technology. In one embodiment, all prices are determined endogenously (that is, without using any exogenous price information, such as information about a midpoint on an exogenous platform). In one embodiment, there is at least one item for which complex orders are admissible and on which the price is not determined exogenously. Note that the item may understood to be a single item such as a house in a real estate auction, or a group of identical items, such as the stock for, say, Apple. In one embodiment, a price on at least one item (or group of identical items) for which complex conditions are admissible, is determined using both an exogenous price (and/or other exogenous variable) and information that is endogenous to the trading mechanism (such as information in the submitted bids).

Further, for illustrative purposes, the following is a non-exhaustive list of goods the present technology may be applied to: public and private sector bonds, bills, notes, stocks (including baskets, like ETF), derivatives (including options, CDS, variance swaps); commodities (including power); oil drilling rights; emission allowances or credits; real estate; online advertising; spectrum licenses; airport landing spots; data capacity; and other goods, tangible and intangible.

As a general comment: any bids consisting only of a quantity that are mentioned at any point in the specification, are naturally always meant to also include the side of the trade (buy or sell), unless noted explicitly.

In one embodiment, complex orders are orders on single items. In one embodiment, complex orders are multi-unit orders or multi-item orders (multi-unit means that the items are all identical). In one embodiment, complex orders are item-less bids with conditions on the state of the world other than the allocation and/or the transfers. In one embodiment, complex orders are single unit orders conditional on the state of the world other than the allocation and/or the transfers.

In one embodiment, complex orders do not include a price, but do include a quantity. In one embodiment, said complex order having no price is for one item and/or for multiple items.

In one embodiment the complex mechanism operates in one shot (such as a sealed bid auction for real estate, or a treasury auction). In one embodiment, the complex trading mechanism operates as a continuous market (such as an exchange, on which executions are possible at any time). In one embodiment, a complex mechanism operates by running a sequence of crosses/sessions/auctions/etc (i.e. orders are executed at specific times, which may be set in advance, or depend on the orders in the system, or be determined randomly). For a more detailed description, see rules around clearing. In one embodiment, a complex trading mechanism operates as a standard exchange (with a limit order book, such as on the NYSE, CME, etc), but is augmented to also receive complex orders. A more detailed description of such an embodiment is below. In particular, in one embodiment, standard orders submitted to the limit order book that is part of the complex trading mechanism, are eligible to be cleared alongside complex orders (which may be hidden). In one embodiment, a complex trading mechanism receives standard limit orders and other orders common on exchanges, and these orders function as hybrid auction bids to be entered into an auction also run on the exchange. In one embodiment, these orders are hybrid orders that participate in a clearing alongside complex orders, where the clearing method may not be an auction method.

As mentioned before, a complex mechanism could be used in one or more steps of a dynamic auction. Now, in the context of illiquid securities, for example, it can be useful to run a mechanism with two broad steps or rounds: an indicative auction as the first step/round, and then an actual auction as the second step/round. What is meant here is that the first round could, for example, be a sealed bid complex mechanism, but that the allocation and/or transfers generated based on the submitted bids would not be executed—instead, this allocation and/or transfers would be indicative. In general, whatever design used in the first round, the resulting trade allocation and transfer calculated would only be indicative. Moreover, depending on the results of the indicative allocation and/or transfers of the indicative auction, an auction would be triggered (i.e. the second round would start).

For illiquid securities and a variety of other applications, part of the challenge is to generate interest for an auction. A designer may allow bidders to submit indicative bids into the first round of a mechanism. This first round may restart each morning and end in the evening, or start in the morning and only end whenever a second round is triggered, or start in the morning and end after some pre-specified time. As for triggering the second round, an auction to buy/sell an illiquid stock the may be started, if the volume in the indicative allocation was above some threshold.

The bids in the indicative round could include quantities and/or prices Alternatively, bids in indicative auctions may also be indications of interest. Bidders wishing to trade an illiquid security may enter a bid that says “I am interested,” or they may also indicate what side they are interested in trading, by saying “I am interested in buying.” In this case, the bids may be conditional on the number of buy and/or sell interests submitted. For example, the indication of interest to buy could be conditional on there being at least N indications to buy and M indications to sell (or conditional on there being N indications to sell by a group of participants, such as pension funds). Solving the indicative bid round could involve finding the largest number K, for which there are K or more indications to buy and K or more indications to sell (one will be binding); similar to finding the allocation that maximizes quantity for the case of a simple uniform price auction.

Running an indicative bid round (coordination mechanism) such as the ones described above may seem unintuitive or risky, because participants may be worried that other traders could fish for their bids, or that there could otherwise be information leakage without the upside of the order ever executing. Thus the trader may not feel incentivized to participate in an indicative bid round. There are a number of ways to compensate and thus incentivize bidders for participating in such an indicative, as well as ways to prevent fishing for information. In order to incentivize participation, bidders who were part of the indicative allocation may receive the benefits of reduced transaction fees in the subsequent (second round) auction, or they may get time priority over bids of the same price in the auction. Fishing can be discouraged by requiring bidders to commit to submitting a bid in the subsequent auction, if it is triggered. For example, bidders may be required to bid on at least x % of the volume that they indicated interest for, and to do so within some reference price range. Or they may be required to bid within a reference price range if the bid they submitted in the indicative round was above a threshold volume. Moreover, the requirements for bidding in the subsequent auction may depend on whether the indicative bid ended up being part of the indicative allocation and transfers. The motivation behind these rules connecting the indicative bid round with the second round is similar to activity rules that are common in dynamic auctions. Note that in dynamic auctions, activity rules are mostly designed to prevent bidders to “jump in” and start bidding towards the end of a dynamic auction, while leaving the task of price discovery to other bidders in earlier rounds. In particular, the rules demand that the traders be actively bidding in previous rounds in order to bid in a current round—while these requirements make sense in multi-round auctions, they may be less appropriate for illiquid securities. The goal of a first round would often be to establish interest in a given security, and then send out an announcement to other traders that are connected to the mechanism but that did not bid in the indicative round, encouraging them to participate in the second round. Instead of an announcement, the start of a second round auction for the security could also be otherwise publicly displayed by the trading platform.

### Operation

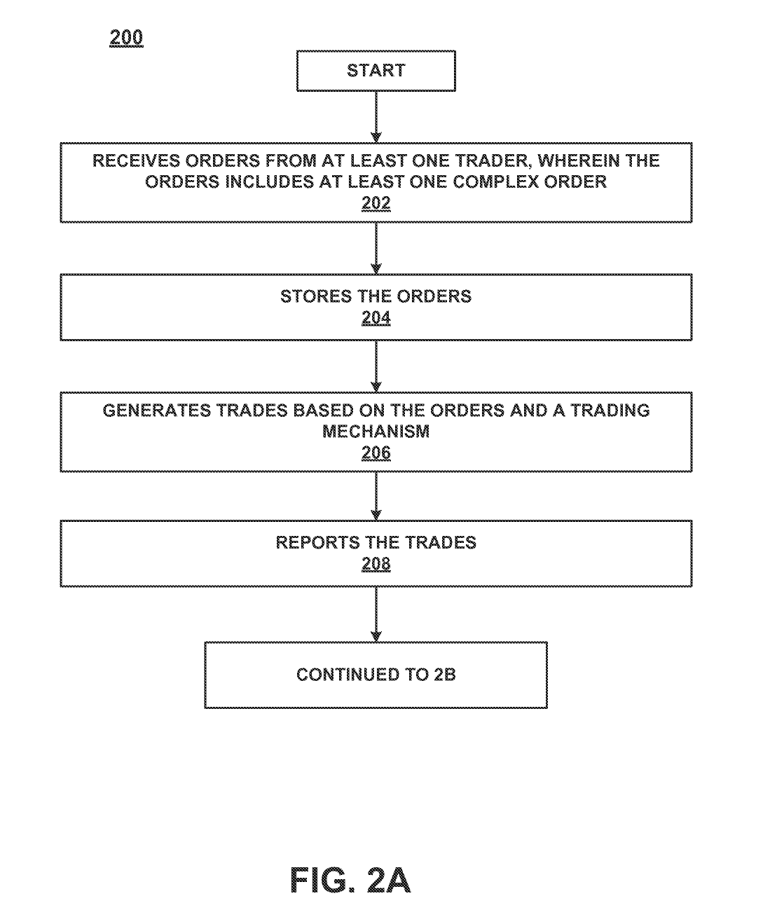

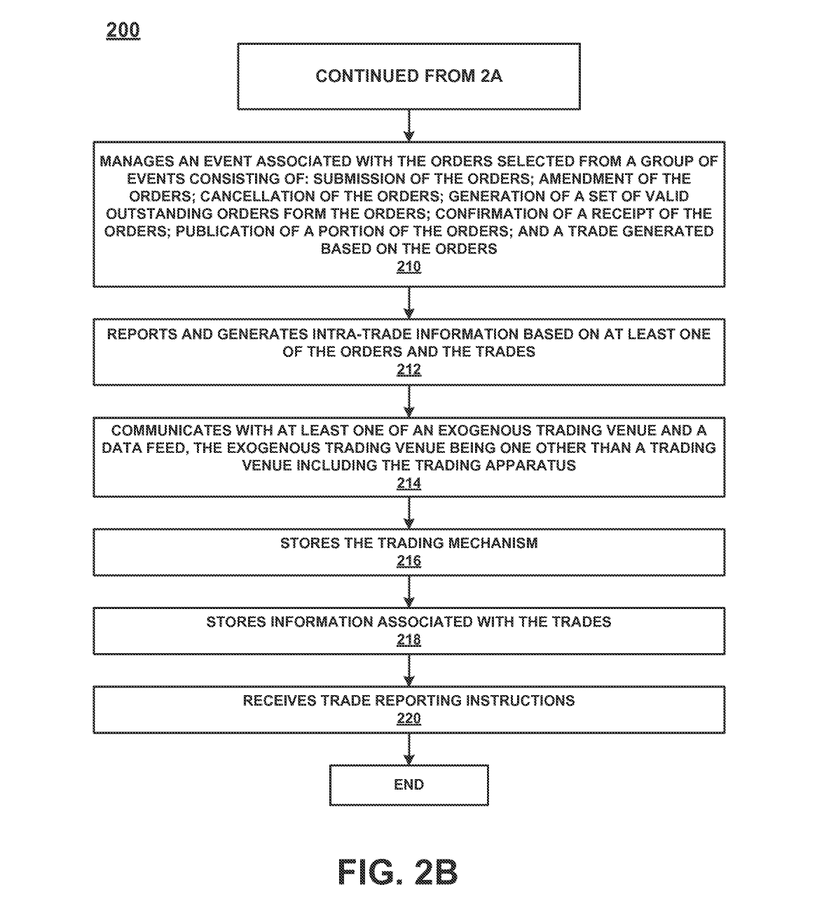

FIGS. 2A and 2B show a flow chart of an example trading method, in accordance with embodiments of the present technology. Of note, it should be appreciated that the steps shown therein may be performed concurrently or sequentially.

Referring now to FIGS. 1A-1C, 2A and 2B, at 202, in one embodiment, orders are received from at least one trader 112. The orders include at least one complex order, as is described herein. The FIGS. 2A and 2B show an example embodiment for the more general complex trading mechanisms, as described in the richer setting. The subset of complex trading mechanisms operating in the simple setting are less complicated and do not involve communication with at least one of an exogenous trading venue and a data feed (pictured at step 214). Thus, it is understood that for an embodiment operating in the simple setting, step 214 would not apply.

At 204 and as is described herein, in one embodiment, the orders are stored.

In one embodiment, the orders are stored internal to the trading apparatus 100. However, in another embodiment, the orders are stored external to the trading apparatus on a storage medium coupled with the trading apparatus, via wire and/or wirelessly.

At 206, in one embodiment, trades are generated based on the orders and a trading mechanism 146. In one embodiment, the orders that are stored at 204, are compared with the trading mechanism 146. Based on this comparing, the trades are executed. In one embodiment, trades are generated via the execution of a clearing method 148.

At 206, in one embodiment, trades are generated with the trade generator 106. In one embodiment, the orders that are stored at 204 are compared with the comparator 120. In one embodiment, trades are generated with the trade executor 122. In one embodiment, trades are generated via a clearing method module 124

At 208, in one embodiment, trades are reported. In one embodiment, the trades are reported to at least one trader 112.

At 210 and as described herein, one embodiment manages an event associated with the orders selected from a group of events consisting of: submission of the orders; amendments of the orders; cancellation of the orders; generation of a set of valid outstanding orders; confirmation of a receipt of the orders; publication of a portion of the orders; and a trade generated based on the orders. It should be understood that the foregoing list of events is non-exhaustive. At 212, in yet another embodiment, intra-trade information based on orders and/or trades is reported and generated.

At 216, in one embodiment and as described herein, the trading mechanism is stored. At 218, in one embodiment and as described herein, a selection of a selectable order input is received from at least one trader 112. In embodiments, the selection of a selectable order input is received by the trading apparatus 100 by any number of input forms, such as but not limited to: voice commands, touch screen, keyboard entry, icon selection via an input control, etc.

At 220, in one embodiment, information associated with the trades is stored. At 222, in one embodiment, trade reporting instructions are received. Of note, in one embodiment, the trade reporting instructions instruct the reporting module on where and what to report. In one embodiment, these reporting instructions may be input via an input device coupled with the trading apparatus 100. In one embodiment, the instructions may be received from the auctioneer system 114. In another embodiment, the instructions may be received from an entity other than the auctioneer system 114

As stated at the beginning, it is to be understood that some of the steps in FIGS. 2A and 2B may happen entirely or partially concurrently.

In one embodiment and as described herein, the trading method 200 operates in at least one round of a dynamic auction.

### Richer Setting

In one embodiment, the auction database receives the bidders' bids and proceeds to calculate and update the set of valid outstanding bids.

Referring still to FIGS. 2A and 2B, at 214, one embodiment communicates with an exogenous trading venue and/or a data feed. The exogenous trading venue is different than the trading venue comprising a trading apparatus, such as, but not limited to, the trading apparatus 100, from which an order is received from at least one trader 112. In one embodiment, the communicating of 214 includes sending a portion of the orders to the exogenous trading venue and accessing information from the exogenous trading venue and/or the data feed.

Trading Rules (Other than Clearing)

The following rules, and any combination of these rules, are consistent with the present technology and to be defined by the auction designer for the each specific embodiment.

In one embodiment, bidders may cancel bids at any time, only after a specific delay time or a random delay time, and these rules may apply to all or some bids, may vary over time, and may depend on the individual bid or the combination of bids submitted so far, or both. Cancelation of bids may also depend on other information contained in the entirety of the auction information, such as for example the history of trades, or the intra-auction information that was sent out.

In one embodiment, bidders may amend bids and, may then lose the bid's time priority, or keep the bid's time priority, or have their time priority delayed by a specific or random time, or a rule that depends on information contained in the entirety of the trading information. These rules for amending bids may vary over time, depend on the identity of the bidder, or depend on characteristics of the bid (for example it's size or whether it has a condition). There may be rules regarding the bids submitted so far by a bidder up until a given time, such as, but not restricted to, a maximum on the number of outstanding bids, and rules that apply to any given time interval, such as a maximum on the number of bids that the bidder may amend or submit within a given time interval. Moreover, these rules may vary over time, with the identity of the bidder and with the bids characteristics, and/or also vary with other information contained in the entirety of auction information.

As for transparency requirements, complex mechanisms leave freedom to the auction designer choosing the specific embodiment (for some markets, regulatory requirements for example with respect to post trade transparency, will restrict the designer's choice). For example, the designer may specify that the auctioneer or the bidders can choose to make public part, or all, of the bid on a bid-by-bid basis, or on all the bids, for part or all of the time (using intra-auction information to do so), or after the auction is concluded. Bidders may choose to publish information or send messages to all participating bidders, or to some subset of bidders.

The intra-auction information the auctioneer decides to disclose may include information about the current bids, or information derived from the current bids, or information about the history of auction results, or any other information. For example the auctioneer may disclose information about realized volatility over the auctions that concluded in the last 3 minutes, or information stating that there is interest in a stock (without disclosing whether there is interest to buy or sell), or information about the likely range of prices that a bid of a given fixed size may execute at (that is, what the likely winning price, if any, of the bid would be in a double-auction). Moreover, at one, some, or all points in time, the auctioneer may decide which set of bidders are to receive which intra-auction message (meaning that not all bidders may receive have the same intra-auction information at all times).

In auctions of the present technology, the auctioneer may exercise choice over the set of auction items sold or bought, and may only announce a candidate set of items to be bought or sold ex-ante (for example, by including that information in an initial intra-auction message).

Regarding monetization of the auction, the auctioneer may decide to charge participation fees, or charge or pay bidders for goods that they buy or sell, much like exchanges charge transaction fees and/or pay rebates for orders that they execute. It is useful to distinguish three categories of charges and rebates. The first category of charges and rebates are the standard charges/rebates existent in the prior art for trading mechanisms and/or auctions: per unit rebates/charges, which may differ depending on whether, for example, the order was resting in an order book (and may be paid a rebate upon execution, since it was providing liquidity) as opposed to being a market order sent to execute against orders in the book (which may be charged a fee for taking liquidity). In some embodiments of the present technology, a second category, namely that of differential charges/rebates may exist: The auctioneer may decide to charge bidders depending on features of the bid. For example, a bidder who won shares in an auction may pay more per share if the bid he submitted included a constraint, such as a minimum execution size, or a condition on the price impact of the order. Or, the bidder may pay more if he engaged in what would be called “order splitting” in a trading context: for example, if the bidder wins a certain quantity in total but the winning quantity was made up from a large number of small bids.

In some embodiments, the auctioneer may also choose to pay rebates or charge fees of a third category, which depend on the clearing conditions at the time the bid is executed (i.e. depending on the state of the world at the clearing). Charges and/or rebates, that is, payments, may vary with the length of time that the bid had been in the set of valid outstanding bids until the auction cleared (this is something a bidder may be able to estimate at any time, knowing when he submitted the bid). Other criteria for determining payments include, but are not restricted to, what the bid's place in the queue of winning bids was (which depends on the auction allocation in a way that is hard or impossible for the bidders to estimate), or how much liquidity the bid or bidder provided (measured by how much the bidder's bid affected the allocation by increasing, for example, the total volume traded, compared to how much would have been traded without the bidder). The rebate or fee in the latter example would capture what is sometimes referred to as a “shadow price” in economics. In some embodiments of the invention, bidders may have the option to specify the maximum amount of fees that they would be willing to pay once the bid executes, for example, on a per share basis.

In some embodiments of the invention, the sum of the rebates paid to the bidders and the fees received from the bidders while implementing allocations may always be positive, but that does not always have to be the case. The auctioneer could charge fees and pay rebates in fourth way, namely one that requires the ability to exercise discretion over the budget, and choose to only balance his budget (so that rebates and fees cancel each other) on some allocations, or even pay at the clearing (if the rebates exceed the fees collected) on others. This flexibility may allow the auctioneer running a sequence of auctions to have better control over trading volume, or price stability, for example.

The auction designer may choose to include any combination of the four categories of charges and/or rebates described above.

### Rules Around the Clearing

In some embodiments of the invention, the clearing step of the auction would involve sending orders to other exchanges and/or other trading venues (such as Alternative Trading Systems in equities). In particular, this would be necessary if routed bids (defined further below) are allowed. The clearing program of the auction may thus, for example, have to be able to access and retrieve information about the outstanding volume at the NBBO in order to include said volume in the database of valid, outstanding bids for the auction. In particular, this may be necessary in applications were regulatory requirements such as trade-through rules require a trading venue that clears at a price outside of the best bid and offer to sweep up any available volume (outside the venue) up to that price. In such a case, the auction program would have to send orders to buy from or sell to the respective offers and bids on the venues currently offering those best prices.

As a simple example, assume that there was only one other exchange other than the complex platform, and that it posted only the first level of the book, with 6,000 shares at the best bid of 10.02 and 10,000 at the offer of 10.04 at the time that the auction starts clearing. The complex mechanism would then read in that bid and ask and include them as unconditional bids to buy and to sell in the auction. Now assume that the auction cleared at 10.06 for a total of 50,000 shares. The complex platform would then send out a market order to buy the 10,000 shares at 10.04. The obtained shares would then be sold to the buyers in the auction at 10.06. If there was more than one other exchange, and various levels of the book, the same logic would apply: all displayed volume on other platforms would be entered as an unconditional bid into the complex mechanism. For a price outside the NBBO, the platform would send out market orders and limit orders with the intent to swipe the available volume up until the auction's clearing-price (in the example above, the volume at 10.04 through 10.06). As a result, the mechanism would intend to protect not just the first level of the book (the 10.04 in the example) as consistent with trade-through rules, but all levels up to the auction price.

Note that from the auction perspective, including volume from other platforms into the clearing calculations introduces a risk of non-execution, as the orders sent out by the auction may not be filled or filled only partially, or not at the expected price. The auctioneer/designer may thus choose to give traders the option to specify how much execution risk they are willing to take (for example, they may accept up to 10% deviation on the volume bought or sold), which would be done by appropriately defining this option in the trader's message space. Alternatively, or in addition, the designer may choose to cover part of or all of the variations due to partial fills (for example, by covering any price differences that arise when trying to fill the targeted volumes as specified at the clearing of the auction). Or the designer may choose to let specific market participants, such as high frequency market makers to take care of the swiping of the other books (as a benefit for achieving a special status, similar to the market maker status that has existed in equities markets for years).

Intuitively, a complex platform as described above would act as an aggregator over other exchanges, allowing to mitigate some of the disadvantages of fragmentation of liquidity. Any amount generated from swiping the liquidity at other exchanges when trades are outside the NBBO can be used to reduce transaction costs on the complex platform.

Moreover, if there were also a standard limit order book on the complex platform, the limit orders there would also automatically become unconditional auction bids and receive price improvement to the auction price. This would give traders an incentive to rout their orders to this exchange, as they would not get price improvement to the auction price if that price was outside the NBBO, but instead only get their limit order price (which would be by construction lower than the auction price for these sell limit orders, and higher than the auction price for these buy limit orders).

The following further illustrates with a simple example, how a complex platform can include both a continuous limit order book and features of an auction. For example, the complex platform could operate a standard limit order book common on exchanges today. In addition (Intuitively, on top of the continuous market), it could allow for bids that are complex and that are eligible to trade in auctions that are run at specific intervals, such as every minute, every 5 min or every hour (and that are intuitively there to aggregate liquidity). The auction run at those specific intervals could have an auction design as those described in categories one through seven. (It could also be possible to run the auction at sub second frequencies, and using any of the Rules around the Clearing and other rules described for complex mechanism. For example, the auction allocation and transfer may only be executed if at least a threshold quantity trades.). Moreover, the limit order bids in the limit order book could function as hybrid limit order bids: they would also be entered as unconditional bids into the auction whenever the auction was run.

As to when to clear the auction, the auctioneer in the richer environment has a number of options. He may choose to clear the auction at a specified time (for example hourly, from 9 am to 5 pm), or clear depending on some condition that can be verified with information derived from the valid bids in the database and/or information exogenous to the auction. For example, the auctioneer may continuously monitor the set of valid and outstanding bids, calculate the resulting allocation and actually clear (and implement) the allocation only if the resulting trade has at least a specific volume, and/or not unless the volatility of some exogenous variable was at most a certain amount. Or, he may clear an auction for a stock only if at least a minimum trading volume is achieved and the difference between the auction's clearing price and the clearing price of the previous auction is at most a specific amount. Alternatively, an auctioneer may also be able to exercise discretion about whether a trade should occur, conditional on a condition being met, for example, if the auctioneer would like to manually instate a trading halt if the drop in prices from one auction to the next was large.

The auctioneer's choices over when to clear an auction, implies that in some embodiments, bidders will know exactly when a trade may happen (for example, when the auctioneer specifies that he will clear the auction at a random second within a given minute), or may not know when the trade may happen or could happen at all (for example, when the auctioneer says he will only clear the auction when there is at least a threshold volume to be executed).

Note that the process of calculating the resulting allocation based on a current set of valid outstanding bids takes time. If a clearing process is started based on the valid, outstanding bids at time t, then the process may not end until time t+D. Thus, it is necessary to specify how to handle bids that are submitted in the time interval [t,t+D], as well as how to handle the cancellations that occur in the time interval (and how this affect the valid, outstanding bids currently used in the clearing process). The auctioneer may specify that new arriving bids are collected in the database and then merged with the remaining valid bids from the cleared auction (that is, the whatever bids or parts of bids did not execute). The auctioneer may allow bidders to cancel bids at any time, but delay the cancellation of bids that are used in a clearing process until after said process has been completed (once the clearing process starts, bids that were valid and outstanding would thus be locked in, which is fairly standard in practice as otherwise the clearing would have to be recalculated any time a bid got canceled, and it may take a long time to clear). Note that the auctioneer also has to make design choices about what to do with bids that were not, or only partially, filled in the clearing process. On possible choice may be to include any unfilled portion of these bids in the set of valid outstanding bids after the clearing.

The following describes an example transition from one auction to the next, when a sequence of auctions is run. First, information about exogenous variables and intra-auction messages may be sent at all times. Now, consider an auction that started at time t′. Say that at time t>t′, the clearing process of this auction starts, and is concluded at time t+D (when trades are also executed). The database of valid, outstanding bids would then be updated (for example, by merging any of the partially filled bids from the clearing that are still valid with the set of valid bids submitted between time t and t+D), and serve as the starting set of valid, outstanding bids for the next auction. Said next auction would be designed to start at t+D. Trade information for the auction that started at t′ (and whose clearing process started at time t) may also be published at t+D, and added to the history of trades available for said next auction. In general, at its start, the next auction would have access to all histories up to time t+D (this includes histories of intra-auction information, exogenous variable information, the set of submitted bids and the set of valid, outstanding bids).

### The Clearing Method

The clearing mechanism for a complex auction mechanism may be that associated with any of the standard auction formats in the prior art, including first or second price auctions for individual goods, and discriminatory price, or uniform price auctions for multi-unit auctions, combinatorial versions of those formats listed so far, other combinatorial auctions, and a general complex trading format to be defined later. Consistent with the present technology is also the inclusion of other standard features such as reserve prices on part or all of the candidate auction items. Note that the auctioneer may also need to specify tie-breaking rules, for example, by specifying that price-setting bids in a uniform price auction may be pro-rated. (A much less common alternative may be to allow for time priority among bids of the same price, such that earlier submitted bids would be filled first. Yet another alternative may be to give priority to bids that do not include a constraint, such as a minimum size, or specific complex constraints). In particular, the tie-braking rules are also meant to include rules as to how to choose among a set of clearing prices (for example, when more than one price is consistent with a given allocation in a double-auction that requires one auction price to be applied to all units bought or sold).

Moreover, the choice of the clearing method may include choosing an objective function. The role of the objective function is to choose the auction allocations and transfers to be executed, in case the clearing method and tie braking rules select more than one candidate allocation and transfers for the auction. Note that the term objective function does not necessarily mean that there exists a mathematical function allowing to automate the choice, but rather refers to criteria that the auctioneer would consider in choosing amongst said candidate allocation and transfers. Possible criteria may include, auctioneer revenues from the auction, auctioneer costs from the auction, gains from trade, trade volume, or other variables, such as equity or dispersion in an auction (which may be captured with statistics based on the auction result). An auctioneer may choose to maximize any one of these criteria, or any combination according to any value function of his choice. The value function may change over time, and/or the auctioneer may “manually” select amongst the candidate auction results. While an automated choice would is the only possibility for many embodiments (in particular any trading applications in which the trades have to be calculated in microseconds), an example in which the option of having a manual choice as an auctioneer can be both feasible and beneficial could be some government auctions: In particular, the auctioneer may find it beneficial to be able to collect the bids and then ponder which one of the different candidate allocations to choose, if the goal of the auction is not only to raise revenue, but to also to take other criteria (like those mentioned above) into account. In fact, a government may decide to take a relatively long time to make the manual choice, because it may decide to put the different candidate allocations up for vote first. In practice, it will likely be advisable to announce ahead of the auction, exactly how the winners will be determined, which would include disclosing the auctioneer's objective function.

To illustrate the implications of the choice of objective function and admissible bids on the clearing process, consider the simple example of a bond issuer who decides to sell a total notional of either 1 billion or 2 billion, and allows bidders to submit bids that include conditions on the total quantity issued. (Bidder j in the previous example would state that he would like to buy at least 600 shares and at most 1000, and would be willing to pay up to 7$ per share if the total issued was 1 billion, and up to 6.5$ if the total issued was 2 billion). One of the reasons bidder j may bid this way is that he may think that issuing 2 billion in debt would be too much a burden on the capital structure of the company. If the bond issuer's objective is to maximize revenue, and he chooses a uniform price auction format, then the clearing process in this simple case essentially amounts to solving two independent uniform price auctions, one for a 1 billion notional issued and one for a 2 billion notional (while considering only those bids that are valid conditional on the respective issuance volume), and to choosing whichever of the two auctions had the higher revenue. Much more detail on the clearing methods of complex auctions is provided further below—the main point is that the issuer would be finding a candidate allocation by solving an auction for each possible state of the world (the state in which quantity is 1 billion and the state in which quantity is 2 billion), and then selecting the final auction allocation among the candidate allocations with the help of the objective function (in this case, picking the candidate allocation with the highest revenue).

In the richer setting, the auctioneer has more choice as to the clearing method chosen compared to an auctioneer running the auction in the simple setting of chapter 1. For example, the auctioneer may choose to maximize a combination of revenue and some metric for price stability, rather than, say, maximizing only revenue. For an auctioneer running double-auctions for a stock using a uniform price auction, a natural metric of price stability could be difference between the last auction price for the stock and the possible price in the current auction, or the realized volatility of the auction prices over a specific time interval leading up to the current auction, once the possible current auction price is included. Generally, in some embodiments of the present technology, an auctioneer may chose objective functions that include metrics formed with past auction results, and moreover, these objective functions may change over time. For example, an auctioneer may include price stability into the objective function only when volatility for the auction good, or for related assets is higher (than, say, some benchmark) around the time of the auction).

In general, the clearing process of a trading mechanism (that is, a trading mechanism, which is not necessarily an auction mechanism), involves taking in a set of valid, outstanding orders and applying a clearing method to said set of orders. The clearing method can be any method specified by the mechanism designer (the designer has complete control and may for example, decide to disregard all orders submitted at uneven seconds, and start an auction with the remaining set of bid, even if that evidently would not be a wise trading format). If the trading format happens to be an auction format, then the trading mechanism belongs to subgroup of trading mechanisms that are also auction mechanisms.

At this point, it is useful to introduce a number of non-auction trading mechanisms that are used in practice, and also explain how complex orders would look like for these mechanisms. This is the easiest way to see how these standard mechanisms could be augmented to become complex mechanisms.

First, consider the trading mechanism used by most exchanges, such as the NYSE. Using the terms introduced in the richer setting, this mechanism includes: a set of admissible bids/orders (including limit orders, market orders, and usually a myriad of other order types), rules for calculating the set of valid, outstanding orders (for example, a stop order to sell may become active, as soon as a stock price drops below a certain limit), rules regarding intra-trading information and trade information (orders in the book may be displayed in entirety, or partly hidden, such as with reserve orders; trades are reported, in accordance with SEC post-transparency requirements). Moreover, the mechanism includes rules as to how to cross orders (that is, how to generate trades based on a set of valid, outstanding orders), and these rules represent the trading format (including tie braking rules).

Embodiments of the present technology include augmenting trading mechanisms in the prior art, such as those used on exchanges and other Alternative Trading Systems in equities, and change/augment these mechanisms to become complex trading mechanism by introducing complex orders. Complex order are defined to be conditional on a state of the world at the clearing (see earlier section), so their presence immediately impacts the way the complex mechanism is cleared (which is described in detail in the next section). Unless specified otherwise, the complex mechanism would find the trade (allocation and transfers) by maximizing the objective that the non-augmented standard exchange or ATS had—which in most exchanges and ATS' around the world is trading volume.

As already mentioned, there are a myriad of possible complex orders, many of which could be used in a complex trading mechanism. Below is a very short list of examples of complex orders that could be introduced into three trading mechanisms. Also note again, that any of the monetization options (such as differential rebates and fees) discussed so far, also would apply in the context of trading.

In a trading mechanism as used by exchanges, traders may be allowed to submit the following complex order: an order that is hidden (not displayed in the book), specifies a price, quantity, and maybe a minimum size, and a complex condition which states that (if, that is, as long as execution of the order happened within the NBBO), the order may be matched only with orders that have been submitted at least 3 min before the execution of their order. Or, traders may include complex conditions stating that they would like to buy or sell a quantity only if the total quantity in the trade was above a specific amount, or above some multiple of the quantity that they end up buying. (For completeness, note that any order that is displayed in the book, or more precisely any quantity displayed, would likely not be allowed to have a complex condition attached to it.) Another kind of complex order could specify a price and quantity to be traded, conditional on there having been at least some volume of complex orders submitted in the last few seconds, which were not immediately canceled and had a price above a certain threshold.

As another example, consider a mechanism such as NYSE Matchpoint. In this case, orders submitted consist only of quantities that the traders wish to buy or sell. The orders are crossed/cleared a number of times during the day, at a price determined on another venue (for example, by choosing the average price over a randomly selected minute of trading on the NYSE in the hour preceding the cross). Since there is no way to balance demand and supply due to the fact that the price is determined elsewhere, orders need to be pro-rated at clearing: if there are more buy than sell orders, all sell orders get filled, while the buy orders are pro-rated; if there are more sell than buy orders, it is the reverse. In this case, traders may be worried that their order gets filled entirely exactly when they were on the wrong side of the trade (a buy order would get filled entirely precisely when there are more sellers, suggesting that prices may move down). This concern may be even more significant for someone submitting a large quantity. A complex bid in this context may include the condition that the ratio of supply and demand may not be more than some number, or at most equal to some number. Or, a complex bid to buy up to some quantity may include a condition that the total quantity traded be at least some multiple of the quantity that the trader ends up buying in the cross.

As yet another example, consider platforms such as pipeline trading, that may send out intra-trading information, which is partly based on the orders that are currently in the system. Pipeline trading, which is geared toward the execution of large orders, invented a proprietary block price range that specifies at what prices an order of 100,000 shares may execute. This range of prices takes into account information about the set of valid, outstanding orders in the system, as well as “fundamental” information about the stock, such as its volatility. A complex order of the seventh category as introduced before, may then include a condition on the effect that the order would have on said block price range. Note that the trader would not know whether his order has not yet executed because the condition is not met, or because there is simply not enough interest on the other side (no buy or sell order to match his order). In order to prevent gaming by traders, auctioneers may also always specify that complex orders of this kind (or complex orders in general) cannot be cancelled for at least some number of seconds.

In other embodiments, a bank may use an embodiment of the current invention by allowing their customers to submit complex orders, generate trade results and either a) execute the trades and then execute any unfilled customer orders somewhere else, or b) not execute the trades, but use the information derived from the trade result to execute all or part of the customer orders somewhere else. The motivation for doing this, that is, for calculating a trade but not executing it, would be for the bank to get a better sense of what the price on the asset should be (if price discovery was improved through complex orders). To the extend that an auction for say stocks, generated a price above the NBBO, the bank would then predict that the NBBO was likely to move upwards soon, and thus use the auction price information to adjust their algorithmic execution strategies (having an advantage over other participants in the market where prices do not yet reflect that information).

Also note that if complex orders were allowed on an exchange or other trading platform, algorithmic trading strategies that send out orders to said venues could be amended to also send out complex orders, as well as to use the information gathered from the execution of those complex orders.

### Discussion of the Trading Mechanisms, Clearing Procedure

Before describing the clearing process, note that after having described the Trading Rules (Other than Clearing) and the Rules Around the Clearing in the previous sections, once the clearing method is chosen, and all bids are collected, the mathematical problem of clearing the auction is fully defined. That is, the clearing method is about figuring out how to find the allocation and transfers for a given set of bids that are eligible for clearing.

In short, solving any of the auctions (or trading mechanisms) that allow for complex bids (that is, both the auctions in the simple setting and the richer setting), and any of the more general trading mechanisms that allow for complex orders (which include auctions, but also other mechanisms), amounts to executing the two steps described below. Note that for ease of exposition, the following descriptions are worded in terms of auctions, but are identical for complex trading mechanisms (in fact, the complex trading mechanisms derived from trading mechanisms used in practice, such as on exchanges, may involve much less computational burden than typical auctions, at each of the two steps).

The process of solving a complex auction mechanism involves:
1. solving/clearing hypothetical auctions (using the auction format and the tie braking rules that are part of the chosen clearing method) for different possible states of the world, and
2. choosing a result of a hypothetical auction (using the objective function defined as part of the chosen clearing method), whose result is associated with an equilibrium in the corresponding state of the world.

In the following, each of the terms described above will be defined. The concept of states of the world comes from game theory and more generally economics. The term state of the world is commonly used in economics to refer to the uncertain outcome, event, or circumstances (of random variables that describes any measurable event; of characteristics of a market, such as its liquidity; of the weather; of the behavior of a collection of agents; etc) at a future date. For example, someone who is looking into the future may think that there are two possible states of the world tomorrow: that it rains, and that it does not rain. Alternatively, someone in a game show may wonder what is hidden behind a door right now, and think that there are three states of the world: one in which nothing is hidden, one in which $100 are hidden and one in which $10,000 are hidden. Moreover, the person may assign some probability to each of the states of the world. Similarly, in an auction, individual bidders may envision different states of the world for things that they do not know at the bidding stage: the bond auction may turn out to be oversubscribed or undersubscribed because other bidders are either very interested or not that interested, a specific bidder may end up winning or not winning a specific item, the auctioneer may decide to issue a larger or smaller quantity of bonds within a range of possible issuing-quantities that he had announced.

In practice, bidders deciding on their optimal bidding strategy will make assumptions over the possible states of the world and the likelihood of these states of the world and then form bids. The difficulty the bidders face, though, is that a specific bid may turn out to have been unwise if a certain state of the world is realized. A bidder who bids in a multi-unit auction that happened to be highly oversubscribed may regret not having bid higher, but chose not to do so in the first place because he knows that his bid affects the price (both in a uniform and a discriminatory price auction), and he is moreover at risk of the winner's curse if the good auctioned-off has common or interdependent values (that is, if each bidder's valuation for the good depends at least in part on other bidders' valuation for the good).

The complex bids of the present technology intuitively allow bidders to include conditions that express what they care about. First, though, note again that with complex mechanisms, as per step 1, the auctioneer solves for hypothetical auctions in possible states of the world. In particular, it is not required to calculate the allocation and transfers for every possible state of the world for a mechanism to be complex.

Step 1 has to be performed on at least two possible states of the world that may be equilibria (for some set of admissible orders), so that it can be possible to make a choice among them in step 2. Equilibria are candidate allocations for a state of the world that are also consistent with the state of the world (more on that below). Thus, for a complex trading mechanism and the set of admissible bids included therein, there have to exist at least two different candidate allocations, each consistent with at least one different state of the world, and each of the at least two different candidate allocations and transfers corresponding to a different at least one set of orders in the set of admissible orders. (For example, two different candidate allocations and transfers may be called (X, T) and (X′, T′), their corresponding different states may be S and S′ and the at least one set of admissible bids for each of the (X, T) and (X′, T′) may be called B and B′.) Generating trades then involves selecting among candidate allocations that exist for the set of submitted bids. Which set of states step 1 is performed on (i.e. which states are relevant for step 1), depends on the specific complex mechanism that the designer chose for a given application (and may vary with the set of admissible bids and the clearing method, as illustrated next).

For example, if bidders are allowed to condition their bids on quantity issued in a range, the possible states of the world refer to the quantities issued in the range, but performing step 1 may not involve solving the hypothetical auction for all possible states of the world, i.e. all quantities. For example, step 1 may not be performed on states of the world where the quantity is not divisible by a lot size, or not it may not be performed on states on which fewer than some number N of bids conditioned their bid on. The choice of what states to solve hypothetical auctions may be automated or it may involve a manual decision by the designer after, for example, observing the bids.

The following examples illustrate how complex bids can help bidders better express their preferences (assuming that these complex bids are admissible within the mechanism), and how the bids relate to the space of states of the world. This description is meant to provide more background in addition to the subsequent description of how perform steps 1 and 2.

If a bidder would like to buy a house in a real estate auction only if his friend wins the house next door, he could include that as a condition of category two. The associated relevant states of the worlds would then be: “my friend wins the house next door”, and “my friend does not win the house next door”.

A bidder in a bond auction may submit a complex bid with a condition on the number n of bids above a specific price p (which would be a complex bid of category three), and the associated relevant states of the world would be: “there are more than n bids above price p”, and “there are n or less bids above price p”.

Or, a bidder in a multi-unit auction may care about the total quantity traded, because he knows that a bid for a given quantity and price will likely have less price impact, the larger the total quantity traded turns out to be (so that he may want to bid more aggressively, conditional on a higher total trade quantity). Similarly, bidders in a bond auction may care about, and like to condition their bid on, the volume issued because said volume may affect the liquidity of the bond in the secondary market (with higher-volume issuances likely being more liquid). As a result, the auctioneer may allow bidders to distinguish three states of the world: one in which the total quantity traded is in [0,q1], one in which it is in (q1, q2], and one in which it higher than q2. Or, the auctioneer may state that the issuance volume will be either in [q1, q2] or in (q2, q3]. Note that if a bidder in the first bond example with an issuance range of [0,q3] submits a bid conditional on, say, the total issued being in [0,q1], the bidder is implicitly partitioning the space of states of the world at the clearing. The space of states of the world is parameterized by quantities between 0 and q3, the bidder is distinguishing states in which the quantity is less than or equal to q1, from those in which the quantity is above q1. The partition of the space of states of the world is thus very coarse: it just has two “broad” states, one in which quantity is in [0,q1] and one in which quantity is in (q1, q3].

In the examples above, it seems as if the states of the world to be considered by the auctioneer are only two or three. And in fact, this would be enough as required for solving complex mechanisms, which involves performing step 1 on different possible states of the world (so formally one would need at least two states), and then making a choice in step 2. For the examples involving total quantity, solving the auction may indeed involve solving only two or three hypothetical auctions in a way to be explained further below.

In auctions for dissimilar objects, though, or when the identity of the winning bidders matter, solving the auction may involve first refining the states of the world that have been “distinguished” implicitly by the conditions in the bidders' complex bids. Again, to distinguish implicitly would mean that the bids implicitly induce partitions on the space of states of the world. Consider the example above, involving the house next door. There are potentially many allocations in which the friend wins the neighboring house, all of which would have to be considered. As a result, solving the auction may involve defining refined states of the world, each corresponding to one specific allocation in which the friend wins the house next door. Thus, a group of refined states would correspond to the “broader” state of the world described by the bidder as “my friend wins the house next door.” In the simple example with quantities above, if one were to refine the two broad states of the world because, the first broad state of the world that is called “the quantity q is in (q1, q2]”, could be the group of the refined states of the world in which the quantity issued is equal to some particular q, where q is in (q1, q2]”.

Refining the states of the world at the clearing stage is especially important when bidders submit different complex conditions. For example, another bidder may include a condition on whether a specific other bidder Y wins a specific house H. In this case, the refined states of the world would be grouped in four different groups (one group, for example being the group of states of the world in which the first bidder's friend wins the house next door, and in which Y does not win H). Similarly, if bidders in an auction for dissimilar goods were allowed to specify a condition stating “no bidder wins more than 5 items” and “at least one bidder wins five items or more”, there would be two groups of refined states of the world that match the states of the world distinguished by the bidders.

The step of identifying the different relevant (groups of) states of the world can be very difficult computationally, so that choosing what complex conditions to allow bidders to express is an important part of the mechanism design. The relevant (groups) of states of the world, are those that are relevant for step 1, i.e. those for which step 1 may be performed (and as mentioned, those states of the world can be a subset of the space of all states of the world). The example with the neighboring house illustrates this computational issue, as it involves enumerating possible allocations in a combinatorial auction, a well-known problem that is computationally intensive when the number of both items sold and bidders is large.

To reduce the computational difficulty, it may be advisable to allow bidders to submit only one complex bid, or to restrict the admissible conditions (such as in the example above, by allowing to condition only on the total quantity being in one of 3 predetermined intervals). Fundamentally, this design choice involves trading off what bidders may want, with what is computationally doable and appropriate for the specific allocation, also taking into account any effects on incentives and strategic behavior of bidders (who may be specifying certain conditions also because they have more information about the items than other bidders). Notice that this design choice/problem is very similar to that arising in combinatorial auctions in the prior art, where all-or nothing bids increase the complexity (i.e. difficulty) for the auctioneer at the clearing stage (all-or-nothing bids are bids that allow a bidder to specify, for example, that he wishes to by goods A, B, and C, but only if he wins them all together). The similarity consist in the fact that a restriction in the bidders message space to make computations easier, is traded off against allowing participants to express more precisely what they want.

After having identified the relevant states of the world (that is, the ones on which step 1 may be performed), the auctioneer proceeds to solve hypothetical auctions in the refined states of the world. Computationally, in some auction designs it is enough (i.e. it is equivalent) to solve hypothetical auctions only for the groups of refined states of the world, which much reduces the computational problem (this point is explained in more detail below). Being able to perform step 1 on an entire group of relevant states, as opposed to on the refined states as a default, is thus part of why it can be useful to group the relevant states of the world to begin with.

The step of solving the hypothetical auction involves first identifying, within the set of valid, outstanding auction bids that were submitted, the set of bids that are valid conditional on the state of the world. For example, if a bidder in the auction above conditioned his bid on the total trade quantity being in [0,q1], then that bid would only be valid in the states of the world in which total quantity is in fact in [0,q1]. Moreover, any bids without complex conditions are valid bids for any state of the world. Thus, in the previous example, a simple bid containing a quantity and price would be valid no matter what total quantity traded.

Having identified the set of valid bids for the state of the world, the auctioneer proceeds to solve an auction based on said bids. The auction is referred to as hypothetical to underline the fact that it is only one of the potentially many auctions associated with the different states of the world.

How the hypothetical auction is run on the corresponding set of valid bids is defined by the specified auction format and tie-braking rules that are part of the clearing method. Note that while solving a hypothetical auction may be computationally hard, the methods employed to do so are standard in the prior art. In particular, while the most general multi-item auctions involving identical or non-identical goods with bids on packages are part of a difficult class of problems (knapsack problems, which are known to be NP hard), the standard method for solving them in practice involves mixed integer programming (MIP) techniques. Auctions naturally map into MIP problems, and commercially available solvers for MIP problems are able to handle auctions, as well as a variety of other involved, very large MIP problems with a variety of constraints successfully for many different applications.

As an aside: mapping an auction into a MIP problem is natural because many goods such as shares of a stock, or a house in a real estate auction, are indivisible. When solving what is also referred to as the winner determination problem, i.e. when solving for the allocation, an integer k would be assigned to describe the number of shares won by a specific bidder, or an integer I/O would be assigned to that bidder winning/not winning the house). Some auctions are of course much easier to solve in that they do not require setting up the MIP problem, such as single item auctions or standard multiunit (uniform or discriminatory) auctions without package bids.

As mentioned before, not all complex trading mechanisms are part of the subset of auction mechanisms. The designer has complete control over all aspects of the design, including the clearing aspects, so that the way in which an allocation and transfers are chosen based on a set of bids may at no point resemble an auction. The designer may define some heuristic, some set of rules to be applied to the bids sequentially to find the allocation and transfers, he may define an optimization problem that the allocation and transfers have to maximize and he may choose to set the optimization up as an MIP problem. The choice of the clearing method is entirely up to the designer, who in step 1 will consequently implement whatever clearing method he chose.

The following paragraphs describe step 1 and 2 for a couple of example cases, along side a discussion of how computational difficulties are tackled in practice, by fine-tuning the auction design. The fine-tuning is done through the choice of message space and is especially useful, if not necessary for complicated cases many items and bidders.

In the following, step, 1, and step, 2, is described for a very simple case, in which the auctioneer decides to sell some quantity of stock with a uniform price auction format, announces that his objective is to maximize auction revenue, and allows bidders to submit bids conditional on the quantity being between 1 and 2 million shares or between 2 and 3 million shares. To be precise, for the first state of the world, [1 million, 2 million], should really mean [1 million, 1.999999 million].

In step 1, it would be necessary to identify the set of valid bids for each of the states of the world. Next, for each of the two states of the world, the auctioneer would reconstruct the demand curve from the set of valid bids (by organizing the bids from highest to lowest price). For each possible total quantity q₁*sold in, say, the first interval of [1 million, 2 million], the auctioneer could then identify the last winning bid p₁* and calculate the associated revenue as q₁* p₁*(formally, the auctioneer is thus solving a uniform price auction for every possible quantity in the interval, and calculating the associated auction revenue). For any quantity in said first interval, let Q₁*(associated with P₁*) be the one with the highest revenue (if there are ties, the auctioneer may choose to brake ties by choosing the quantity that is largest). For the simple case described here, with bids conditional on only the two intervals, there will be no need to break ties, though, because the highest quantity will also lead to the highest revenue (this would not necessarily hold in cases in which the bidders were submitting bids conditional on any quantity in the range). Note, though, that Q₁* may not exist, namely if the total quantity demanded aggregating all bids conditional on the total quantity being in [1 million, 2 million] (i.e. in [1 million, 1.999999 million]) is below 1 million. If Q₁* exists, it would represent an equilibrium for the state of the world in which total quantity is in [1 million, 2 million] (and of course, in the state of the world in which the quantity issued is exactly Q₁*). In other words, for the allocation to be an equilibrium it has to also consistent with the state of the world for which it was calculated.

Next, the auctioneer would repeat the process for the second interval, with quantities in [2 million, 3 million], and may find another equilibrium in Q₂* (associated with P₂*). Again, the allocation would be an equilibrium if it was consistent with the state of the world for which it was calculated, in this case, if between 2 million and 3 million shares were bought. The presence of an equilibrium in the upper range may intuitively mean that interest in the auction was relatively high. Note that for ease of exposition, the auctioneer is being defined as the one executing the steps here—in practice, this would be done by the algorithm implementing the clearing method.

In step 2, the auctioneer would use his objective function (which is to maximize revenue) to choose between any available equilibria. In this, case, if equilibria associated with Q₁* and Q₂* exist, he would pick the one with the highest revenue. Note that allowing bidders to condition bids on the total quantity in this example does not help the auctioneer if the auction is undersubscribed anyway (so that neither Q₁* and Q₂*exists, or only Q₁* exists), but may allow an auctioneer to take advantage of the level of oversubscription if the auction turned out to be in fact oversubscribed (that is, as opposed to choosing an fixed quantity to be sold ex-ante, of say, 1.5 or 2 million, he now can take advantage of oversubscription and end up issuing 2.3 million, for example).

Stepping back, clearing an auction with complex bids involves solving a number of hypothetical auctions for specific states of the world. The formats of each of these hypothetical auctions, though, will most often be a standard format existing in the prior art, and thus involve standard methods for solving these auctions/mechanisms. In particular, the class of MIP problems is known to be capable of handling a large variety of mechanisms.

The previous example is a very simple because the hypothetical auctions to be solved for each state of the world were standard uniform price auction, which are easy to solve. In many applications of auctions of the prior art in practice, though, solving said auction is difficult. For example, minimum execution size constraints on bids (which are common) in a standard uniform price auction, turn said auction into a combinatorial uniform price auction: bidders still have to pay the price of the lowest winning bid, but the winner determination problem is a set-packing problem and thus belongs to a class of problems shown to be NP hard. Again, while this problem is difficult in its generality, such auctions are commonly solved even at large scales, by mapping into the associated MIP problem. One way to reduce the complexity (i.e. difficulty) of the computation is to allow only for minimum execution sizes that are quoted in lots of, say, 1,000 shares.

As mentioned before, determining winners in auctions for dissimilar goods, especially in the presence of all-or-nothing bids (package bids), also involve solving very difficult combinatorial problems. For these combinatorial problems, it is for example necessary to include sophisticated tie-braking rules, which may depend on the specific application. In order to render these auctions tractable in practice, auction designers have chosen to reduce the set of admissible bids (for example, by limiting biddable combinations, or restricting the number of all-or-nothing bids a bidder may submit), or restricting the set of auction items that bidders can bid on to begin with. Some degree of freedom also exists as to what to do with bids whose constraints are binding: for example, in uniform price auctions to sell a fixed quantity, auctioneers have in the past chosen to reject bids whose minimum quantity was binding, even if including the bid lead to higher revenue. This choice was made in part because it reduced the computational burden of solving the auction, and in part because otherwise, bidders had an incentive to bid lower on a larger quantity and include a minimum execution size, hoping to be chosen over a potentially higher bid without a minimum execution size (which may have happened, depending on the volume and prices of the next lower bids).

As evident from the previous paragraph, allowing bidders in the previous example to include a minimum size restriction in their complex bids would imply that the hypothetical auctions to be solved become combinatorial uniform price auctions. As a result, clearing the overall auction with complex bids conditional on the quantity issued and conditions on minimum execution sizes would be correspondingly harder. Design choices may have to be made to guarantee tractability (much like may be necessary for standard uniform price combinatorial auctions), and these choices may include, as above, allowing minimum sizes to be expressed only in lots of a given size.

Resuming: In general, the auctions of the present technology may be difficult to solve because they amount to solving a collection of hypothetical auctions which may already be hard to solve. It may be counter-intuitive to want to increase the level of difficulty of a theoretical problem that is already difficult to solve. The level of difficulty of each of the individual hypothetical auctions (and thus of the complex auction) will depend on the number of goods being auctioned off, the number of bidders, the number and kind of complex constraints that the bidders can and do submit, the interaction of these bids, and the clearing method chosen by the auctioneer. It is important to note, though, that an auction designer can choose the specifics complex auction mechanism in a way that is most appropriate for the specific application, while guaranteeing tractability of the complex auction. In particular, as explained above, most of the difficulty does not come from having to perform step 2 (which simply involves ranking the results from step 1 and choosing one result based on the objective function). Most of the difficulty comes from having to solve for allocations and transfers in a given state of the world (which is a standard auction problem), with the constraint that the result has to be consistent with the state of the world in order for it to also be an equilibrium. Depending on what the state of the world represents, it may be enough to just solve for the hypothetical auction in the state of the world and verify after the result is an equilibrium afterwards (as in the example with the stocks sold in two ranges), in other cases an additional constraint is to be added when solving the hypothetical auction (which is discussed in some of the examples below, and can be done easily for a wide variety of applications and complex bid categories).

In the following, a number of examples of complex auctions are described, in order to even better illustrate the two steps 1 and 2 described above.

Consider the case in which one good is sold and bidders can submit bids conditional on there being at least some number of bids above a price P₁, or there being at least some number of bids in an interval [P₂, P3]. In this case, the auctioneer would have to run auctions for the state of the world implied by the prices and minimum number of bids that the bidders specified in their conditions. For a specific state of the world, for example the state of the world in which the price is in [P₁, P3] (which would imply that P₂<P1<P₃ above) and the number of bids is above n, the auctioneer may find that the corresponding set of valid bids does not in fact contain n bids in the interval [P₁, P3]. If so, this state would not constitute and equilibrium. That is, it would not be possible to find an allocation and transfers that is consistent with the state of the world (which requires that there are n bids in the interval). Instead, the auction process may find another equilibrium, associated with the state of the world in which the price is in the interval [P₁, P3] and the number of bids is above n′, where n′<n. This state of the world would then be an equilibrium if there were at least n′ bids. The kind of complex bids in this example are bids of the third category, as these are conditions on simple statistics derived from the submitted bids. A similar example in this third complex bid category would be complex bids in a multi-unit auction that conditions on the average winning bid being in a certain interval, or above a cutoff. In this case, the auctioneer would start with a state of the world corresponding to some average, or an interval of the average, run a hypothetical uniform price auction in each of these states of the world and then select the best equilibrium found. As mentioned before, this scenario with a uniform price auction could be handled with standard MIP techniques that are common in the art, also accommodate the added (linear) constraint on the average winning price.

Next, an example of the fourth category could be the case in which bids are conditional on a variable, such as price impact. To start out with a simple case, consider a multiunit auction for some security. The auctioneer announces that he will use a uniform price format to sell some quantity Q of a security, that the objective is to maximize revenue, and that bidders are allowed to condition bids on price impact, namely by specifying that the price impact L per unit won (or, in a different design, on average over the units won) may be at most L* (where L* is some fraction of a cent, specified by the bidder). The term L, in reference to the Greek letter lambda is used, because conditioning on price impact is similar to conditioning on the depth of an auction, or on liquidity (where the term liquidity is generally referred to as lambda in the context of trading or double auctions). This is a very simple illustrative example: bidders in practice are much more likely to prefer to be able to say something like “I want 100,000, for at most $30, I want 50,000 at a minimum, I do not want the price impact to be more than x cent on the first block of 50,000 and then not more than y cent for each block of 10,000 after that”. That is, bidders care more about the price impact of their bid the larger the number of units already bought. This is well studied in auction theory in the context of demand reduction, where bidders shade their bid on a given unit more strongly away from their valuation the more infra-marginal units are present (i.e. the more units they already won).

After collecting all the bids (complex and non complex bids), solving the auction amounts to considering different states of the world, distinguished by the price impact L that winning bids will have. For any state of the world L**, the set of valid, outstanding bids would comprise any non-complex bids, as well as all the complex bids that specify the price impact to be at most L*, with L*>L** (that is, these are all the bidders who would accept a price impact of up to L* for their orders, and therefore also accept the smaller price impact L**). Note again, that this is a very simple example, if bidders were able to specify different impact levels on different blocks/volumes of quantity, then the state of the world would not be described in such a simple way, but may correspond to a vector with multiple entries, describing the price impact of orders of different sizes. (For example, the first entry of the vector may describe the impact of 10,000 shares, the second entry the impact of the next 10,000 shares etc. Solving for the allocation and transfers in a uniform price auction like the one described in this example, when bids with these more differentiated price impact conditions are admissible, is more involved computationally (that is, the computations for a given state of the world, which is now parameterized by a vector, are more involved and represent a combinatorial problem, which then can be expressed as an MIP problem). The basic procedure, though, is the same, and amounts to finding allocations and transfers that are equilibria for different possible states of the world, and then selecting among them.

Having identified the valid bids, these bids are then ordered by price to recreate the demand curve for the state of the world in which L<L**. Note that L<L** is written here as opposed to calling the state of the world just L**, to underline that any winning units that are part of an allocation and transfer in this state of the world have at most a price impact of L** just like the conditional bids specified by setting an upper bound on the impact. The price impact of a bid (in the state of the world L<L**), more precisely, the price impact of any unit won that is part of a winning bid, is now defined as: the difference between the price p that would clear the hypothetical auction for said state of the world, and the price p′ that would clear said auction if the unit was removed from the set of winning bids, and the highest losing bid was instead included in the set of winning bids. Similarly, if bidders state the price impact condition for averages over units won, the price impact of a winning bid of some number n of units for a given bidder (which may be only a portion of the total quantity he bid on), would be calculated by taking the difference of the price when the winning bid is included and the price when the winning bid is replaced with the next n highest-priced units in the demand curve, and dividing that difference by n.

In order to solve the hypothetical auction for each state of the world L<L**, the auctioneer has to select what portion of the submitted bids will be winning, and may, for example, find that there is no collection of winning bids that is consistent with a price impact of L<L** for all of the winning bids. That is, there would be no equilibrium in that state of the world, because there is no allocation and transfers consistent with the state of the world.

Intuitively, what the price impact condition captures is the shape of the demand curve to the right of the last winning unit. This information is important to bidders, especially if the good has common values or interdependent values features so that the bidder's valuations depends on what valuations other bidders have for the good. Moreover the information matters for bidders who plan to resell this good later (such as dealers bidding in a treasury bill auction, well knowing that they will be reselling the bills in the secondary market for on-the-run bills later). Conditioning on price impact allows bidders to “look” at the shape of that demand curve, and “see” as far (in terms of quantity), as they are buying quantity: that is, a bidder who bids on a larger quantity with a complex bid including a price impact condition, sees further than a bidder who submits a bid for a smaller quantity. More specifically, the price impact captures what happens as the demand curve, starting with the first losing bid at p, is shifted to the left by an amount equal to the units won (i.e. quantity of the winning bid) by the bidder, and said demand curve intersects with the vertical line at Q at some new price p′ (with Q being the total, fixed, quantity sold in the auction). That is, bidders are inherently prevented from gaming, as the only way to see more is by actually buying more units. The ability to see what the demand curve looks like may allow bidders to be less concerned with the winner's curse. In essence, they are able to submit bids that guarantee that they win more quantity only if the market is deep. Note again, that this is a simple example. In more complicated embodiments than the one described in this simple example, the way in which price impact conditions are expressed may be more nuanced, as mentioned before, and the way in which the price impact in which the impact is calculated (that is, in which p′ is calculated) may also be more nuanced (for example, not all currently losing bids may be used and/or not only bids from that group of losing bids may be used). Nevertheless, the guiding intuition of the simple example remains is the same for more complicated embodiments.

The problem of determining the set of winning bids in each state of the world L<L** is combinatorial, as the auctioneer has to decide on the best (highest revenue) way to choose Q winning units corresponding to some collection of winning bids (again, winning bids may only be a portion of the quantity associated with the submitted bid), and then choose the auction allocation and transfers associated with the state of the world in which the revenue is maximized.

Another way in which bidders can condition on price impact may be by including conditions stating that the price impact of a fixed quantity Q of units may not be more than L*. In this case, all winning bids would be able to “see” as far as Q down the demand curve in the associated state of the world. This kind of price impact condition may be useful in cases where the auctioneer wants to allow bidders to adjust their bids to the level of oversubscription of an auction, for example (as opposed to the previous case, in which the complex bid allowed bidders to protect themselves more from the winner's curse).

The complex bids with conditions on price impact can also be part of a double auction with uniform price format. Consider the first of the examples on price impact above: in a double auction the buyers may include conditions stating that L_{D}<L*, and the sellers may include conditions stating that L_{S}<L_{S}*, where L_{D} refers to the price impact on the demand side and L_{S} refers to the price impact on the supply side for each unit bought/sold. As a result, the states of the world that the auctioneer needs to consider are combinations of L_{D}^{**} and L_{S}**, and then proceed from there as in the case of the auction above. Intuitively, the price impact conditions now allow buyers to “see” what happens, as the demand curve starting with the last losing bid at the intersection with the supply curve, is shifted to the left (by the amount of the units won) and intersects the supply curve at a new point p′. And it allows sellers to “see” what happens as the supply curve, starting with the last losing bid to sell, is shifted to the left (by the amount of the units won) and intersects the demand curve at a new point p′. Thus, the price impact captures the relative shapes of the demand and the supply curves.

Conditioning on price impact in double auctions, or in any trading mechanism, can be beneficial for traders by allowing them to be less concerned with the winner's curse and to trade more whenever the auction (or market) is liquid. In particular, consider the case in which auctions are run multiple times a day. Bidders may be concerned to bid aggressively in a given auction for fear that the price impact of their bid may be large if the auction is not deep.

In practice, there is ample evidence that traders choose to adjust the quantity they trade to the depth of the market. Traders choose to split larger orders into child orders, both across trading platforms and over time, as to reduce information leakage and the possibility of being front run. The child orders are then “small” with respect to the current amount of volume traded on each venue. Dynamic trading strategies such as VWAP algorithms (Volume Weighted Average Price), moreover calculate historical volume profiles for, say, an individual stock, and then work a larger order to buy (or sell) that stock dynamically over time, trying to buy (or sell) more when trading volume is higher (and thus price impact lower).

While order splitting is common, markets may be two-sided in many cases, in the sense that there is a significant interest to buy and sell, even if that liquidity is not visible on order books across trading venues. A double auction with complex bids conditioning on price impact would allow bidders not to have to be concerned with “moving first” and being front run: instead, the bidders could bid a price and have control over the associated price impact through the complex bid.

Next, it is important to mention an alternative way to reproduce a complex auction: rather than allowing bidders to condition their bids on the states of the world, the state of the world could be entered into the item definition of an otherwise standard auction. For example, instead of complex bids on item A, conditional on there being at least 5 other bids, the auctioneer could allow bids for the following two items: “item A when there are at least 5 bids for item A” and “item A when there are less than five bids for item A”. Similarly, rather than allowing bidders in a multi-unit auction to condition their bid on the total trade quantity being above or below 1 million shares, bidders could submit bids for two different items: “shares that are sold as part of a total quantity of shares of 1 million or above”, and “shares that are sold as part of a total quantity of shares of less than 1 million”. In these two example auctions, the auctioneer would announce ex-ante that only one of the two different items would be sold. Solving the auction would involve the same steps of solving hypothetical auctions for the groups of refined states that correspond to the states of the world as defined by the items (much like in the standard definition of a complex auction, where the bids implicitly partitioned the set of refined states of the world that were relevant). Specifically, an auctioneer would run a hypothetical auction for each state of the world, using all the bids for items associated with said each state of the world (the hypothetical auction, for the state of the world in which over 1 million share are sold would thus use all the bids for the item “shares that are sold as part of a total quantity of shares of 1 million or above”). This way of designing a complex auction is less intuitive, which is why the description complex mechanism in the specification is geared towards allowing for complex bids instead of “complex items”.

Next, note that a complex auction mechanism may involve solving different types of auctions in different states of the world: for example, in a multiunit auction to sell a good, the auctioneer may specify that he will issue either a small or a large quantity and that a discriminatory price auction may be run in the state of the world in which the quantity is small, and a uniform price auction be run in the state of the world in which the quantity is large. The auctioneer (or mechanism designer), may also decide to run an auction in some states of the world, and match orders with a non-auction trading format in other states of the world, which would imply that the overall mechanism would be a complex trading mechanism, as opposed to a complex auction mechanism. In particular, as mentioned before, the designer the mechanism as he sees fit. The mechanism for a given state of the world may be “always run a first price auction”, but it may also be a non auction mechanism that says “if at least 5 bidders conditioned their bid on this state of the world, then run a first price auction; if less than 5 bidders conditioned their bid on this state of the world, then do not execute any trade” or it may say For example, a designer in an auction to sell multiple units of an identical goods, may allow bids conditional on the number of participants in an auction. For the case in which there are at least some number N of participants, the design may involve randomizing between a uniform price auction, a discriminatory price auction, or some other format to find the allocation and price. Or, for that state of the world of at least N participants, the design may involve always using the same procedure to calculate the allocation and transfers, but that procedure may involves randomization. For example in a multiunit auction, a design may involve randomly assigning bids into two groups, then kicking out the bids in the first group, and running a discriminatory price auction for the remaining ones (the bidders in that group would thus buy the items and set the price); or setting a price p to be equal to the third lowest bid from the second group, and then selling the units at price p to everyone in the first group who bid higher than p (or to everyone in the second group who bid higher than p) all the while giving priority to the higher bids when determining who in the group gets to buy, or instead randomizing over who buys in the group, or following whatever other allocation rule chosen by the designer.

Note that whether a specific trading mechanism (such as one that has the features from the previous example) is wise or not is a question separate from whether the design is complex. Randomizations used in any part of an auction or trading mechanism design may seem unintuitive, unwise, or even unfair at first glance, in part because they are not very common in practice/financial markets. Randomizations, though, commonly appear in the contexts of game theory, mechanism design theory and contract theory (mixed strategies and finitely versus infinitely repeated games probably being the two best known basic examples). Moreover, there are many scenarios in which randomizations have positive effects on the behavior of agents, and the outcome of games, contracts, etc, by affecting the player's incentives.

Finally it is useful to put the complex auction format in context to dynamic auctions that exist in the prior art. These auctions are run in a number of rounds, starting with the initial round, and ending in the final round, when the auction is terminated. In each round, there may be a set of current prices for the items to be sold (note that the items to be sold, for example, the quantity of a bond to be issued, may change over time). As the auction is run, the auctioneer communicates information back to the bidders, and usually allows the bidders to change their bids in every round. Bidders may submit bids for the current round, wherein the bids are dependent on information revealed in past rounds, and they may also submit bids that are to be valid in future rounds. The auction is started in the initial round and terminates in the final round when an equilibrium is reached (that is, when supply and demand are equated). Some of the dynamic auctions in the prior art try to mitigate the same problems that the complex bids in the first and second category try to mitigate. For example, bidder j could adjust his bids in each round in a way to prevent a specific bidder from winning a specific item.

Complex mechanism differ from standard dynamic auctions with multiple rounds in two ways: first, the information communicated to the bidders in the rounds of a dynamic auctions will likely include information that is relevant to the state of the world that will be revealed once the auction terminates. For example, bidders in an auction may find out over the course of some rounds that there is a lot of competition and the auction is oversubscribed. In contrast, any information that represents a valid condition for a complex bid for a given bidder l specifically has to be information that has not been communicated through intra-auction information to said bidder i (as then the information would be available to him already). Intuitively, in standard dynamic auctions, bidders thus have more options to adjust their bids to what they find out as the auction progresses (any information they find out in the course of the rounds is information they can use to adjust their bids). In contrast, bidders in complex auctions have to specify what they would do if they did find out something, i.e. what they want their bid to look like conditional on the state of the world—but the admissible conditions on the state of the world are restricted to those in the message space that the designer chose. Second, even if a dynamic auction was run in a completely automated way, and as a sealed bid auction (not allowing any bidder to change their bid in any round), the auction would remain, by construction, path dependent. That is, the dynamic auction starts at some point and end as soon as an equilibrium is reached. In particular, the decision to end the dynamic auction is made in some round n, which is currently being calculated, and the algorithm cannot “look into the future” and make a decision about whether or not to terminate the auction in said round n based on bids to be valid in future rounds after round n.

Sometimes, the equilibrium found in the dynamic auction would be the same that in a complex auction. If there is more than one equilibrium, though, there is no guarantee that the equilibrium found by the dynamic auction is the best equilibrium: it is just the equilibrium found first (on the path that was started in the initial round). The complex auction, on the other hand, would first identify the set of all equilibria (without even having to consider if they could be reached by a path of a dynamic auction) and then choose the best equilibrium in the set.

Standard dynamic/multi-round auctions could be augmented to become complex mechanisms (as mentioned earlier). For example, a dynamic auction may allow for complex bids in its first round. The motivation for this design would be to leverage the advantages of complex bids to chose the best possible initial point for the dynamic auction, and then proceed as is standard in the art, without using complex bids. Note that while complex bids could be used in each round of a dynamic auction, this may not be advisable. This is because dynamic auctions are meant to start at some initial point and then converge to an equilibrium (smoothly), discovering the prices and the allocation smoothly along the way—while complex bids may lead to large variations in the set of tentatively winning bidders and tentative prices in each round.

### Discussion of the Trading Mechanisms, Motivation

It is useful to point out the possible advantages of complex auctions. In practice, the fact that bidders anticipate the existence of different possible states of the world, such as “the auction is highly oversubscribed”, and “the auction is undersubscribed”, and the uncertainty that this signifies for bidders, complicates the choice of optimal bidding strategies. As a result, complex bids may reduce this difficulty and allow for simpler bidding.

Complex bids generally may benefit bidders also because they allow the bidders to differentiate between—and essentially exclude—, some auction results that they may find unfavorable, which in turn reduces some of the ex-ante uncertainty the bidders face along with the associated risk of exposure, which in turn may induce the bidders to bid with more confidence.

Said benefit may be especially pronounced if the goods have common values or interdependent values (in that a bidder's valuation for the good depends at least in part on what other bidder's valuations are), and bidders fear the winner's curse, and even more so if the bidders' uncertainty about the value of the goods is significant, so that the auction may suffer from lower volume.

Even for goods of pure private values, though, the complex bids may be attractive, when either more than one substitute good is auctioned off, or when a sequence of auctions is run (such as a number of daily auctions for a stock) and liquidity in any given auction may vary (so that a large buyer may not know in which auction a large seller may be participating, or bidding aggressively). In particular, the present auction system would allow bidders to submit bids that are more aggressive the more liquid the specific substitute good was, or, in the case of a sequence of auctions, the more liquid a specific auction was. In both cases, the complex bids would implicitly allow bidders to guarantee that they buy/sell more whenever the liquidity/depth of the auction was higher. In simple terms, bidders would be able to “coordinate on liquidity”: they would trade more if everyone else were trading more, too. No trader would have to show their hand (submitting a large order, adopting an aggressive trading strategy) and fear information leakage—orders would simply execute when there was enough liquidity. For the case of the sequence of auctions, the complex bids would also allow a large buyer and seller to “find” each other, and thus solve the sequential coordination problem of deciding in which auction to bid (by being able to bid on large quantities without having to fear significant price impact).

Other than sequential coordination problems, the complex bids may also help to mitigate more general coordination problems that arise in auctions, such in the example of two friends in a real estate auction who may want to buy houses that are adjacent to each other. Or, for example, a group of companies deciding which technology patents to buy, or which mall to buy together to develop it later.

Next, as explained above, clearing complex auctions amounts to solving a number of hypothetical auctions (which may in turn represent combinatorial problems), and then choosing (with the help of the objective function) the result of one of the hypothetical auctions for which an equilibrium exists based on the submitted bids. In the context of game theory, this process parallels identifying the set of possible equilibria of a game, and then engaging in equilibrium selection, namely choosing the equilibria associated with the most beneficial outcome. In game theory, multiple equilibria exist for many games and this is usually not a desirable feature of the games, because players in the game may have no way of coordinating which equilibrium to choose (that is, they have no way of selecting an equilibrium) and may end up in an equilibrium unfavorable to all of them.

In practice, multiple equilibria may exist and matter, without there being an obvious way to selecting an equilibrium either (this is described in more detail below). Moreover, if multiple equilibria exist in the context of an auction that is to be run, these multiple equilibria may be reflected as the multiple equilibria found in the clearing process. Only that in this case, the auctioneer can in fact choose the most beneficial one (more precisely, the most beneficial equilibrium is chosen by the objective function specified in the clearing method). If so, the existence of, and choice over, multiple equilibria is precisely one of the advantages of the complex mechanisms.

Regarding multiple equilibria in practice, consider the following four examples. The first, and maybe most classical example, is that of a bank run, which (in simplified terms) can be thought of as a case in which two equilibria exist. One equilibrium: For fear that a distressed bank will collapse, all customers try to take their money out at the same time, so the bank collapses. Another equilibrium: customers of said bank generally believe that the bank will remain solvent, and the bank recovers from its difficult position in some time.

The second example is that of multiple equilibria in the context of systemic risk in a banking system, a problem that has garnered attention from regulators and academics in recent years. Given a system of interconnected banks, one could (again, simplifying) consider two states of the world/equilibria: one in which most or all banks fail (because banks are connected through lending relationships with each others, and/or by virtue of holding similar assets, whose prices are likely to have declined due to forced liquidations/fire sales by the distressed banks), and one in which all banks remain solvent. Choosing equilibria, as one would in the clearing process of an auction, is not possible in practice. Regulators instead work towards building confidence and avoiding the collapse of any systemically important financial institution.

The third example, that of gridlock in trading, is likely most closely related to applications of the auctions in the current invention. Trading volume and price discovery for a security may be—and remain—low, because buyers and sellers refrain from submitting bids or offers for large quantities given that the bids are bound to have large price impact due to the lack of depth, and the bidders may not be sure about the correct price for large quantities to begin with, due to the lack of price discovery. In this market, there may, though, also exist an equilibrium with liquidity, in which more volume is traded and price discovery is better, because, conditional on a large total trade quantity, bidders would be less concerned about the winners curse (being significantly off in their estimate of the correct price for the asset) and the price impact of their order, and submit bids that specified relatively larger quantities and more aggressive prices.

The problem in practice would then be how to move from one state of the world/equilibrium to the other. The market will be liquid if bidders bid on larger quantities, but that in turn is only likely to happen if markets are liquid—a chicken and egg problem. In this case, a double auction in which bidders are allowed to include bids conditional on the volume traded may help: the clearing process would likely recover the equilibrium that is consistent with the gridlock (that is, and equilibrium in which total volume is low, and individual bid quantities conditional on that low volume are also small), and the other equilibrium in which liquidity is high (with larger bid quantities conditional on larger total volume traded). Being able to choose the liquid equilibrium over the one representing gridlock, may then kick start trading, improve volume, welfare for the participating bidders, as well as increase price discovery, compared to the pre-auction gridlock state.

As a fourth example one could think of a bar, which may be full, making it popular and attracting more people, and causing it to stay full. Or the bar may be mostly empty, making it unpopular, and not attracting anyone, thus staying mostly empty. Once in one of the equilibria, the bar will stay popular, or unpopular for a while, and moving from one equilibrium to the other (that is, selecting an equilibrium) may be difficult. Similarly, companies bidding for a slot at a industry fair may be more willing to bid at all, or bid higher, if they think that a lot of other companies will choose to go as well, so that the fair would be popular, likely attract more media coverage and make it worthwhile to invest the time and human resources to be represented at the fair. Organizers of fairs, or events may find complex auctions useful, knowing that in practice, it is usually much easier to sign on more clients when some other clients have already signed on.

Finally, the auctioneer's discretion at the clearing stage over the set of auction items to be sold may allow better control over variables that depend on the auction results, such as revenue or the auction price in a multiunit uniform price auction. Bidders in these auctions understand that the set of auction items sold is endogenous and may adjust their bids accordingly as a result. Nevertheless, having discretion over the items sold provides the auctioneer with an option that is similar to being able to simultaneously run a number of auctions in the prior art at once, each with a different set of auction items, and choosing the auction that has the best result. For example, specifying a uniform price clearing method and only a range for the total volume to be issued in a bond issuance, while allowing bidders to condition their bids on the total quantity issued, would be similar to running a uniform price auction for each quantity in the volume range and choosing the favorite auction (for example, the auction whose respective quantity had the highest revenue). Or, specifying a uniform price clearing method and a total of volume to be issued between two bonds A and B would be similar to running simultaneous auctions for every combination of volumes for bonds A and B that generate the targeted total volume, and choosing the favorite combination of volumes issued of each A and B.

In other words, giving an auctioneer choice over the set of items sold or bought at the completion of the auction may allow him to better adjust to circumstances he cannot foresee ex-ante. For example, a bond issuer may be able to take advantage of a higher than expected level of oversubscription by choosing an issuance volume towards the upper end of the range. Or, he may have better control over revenue raised by choosing the optimal combination of quantity issued and price. Or, if he is concerned about controlling the auction price, maybe because of the effect on a secondary market, he may choose a non-revenue maximizing smaller quantity that prevents over-supply in the market and supports a target interest rate.

The following are further embodiments of the present technology:

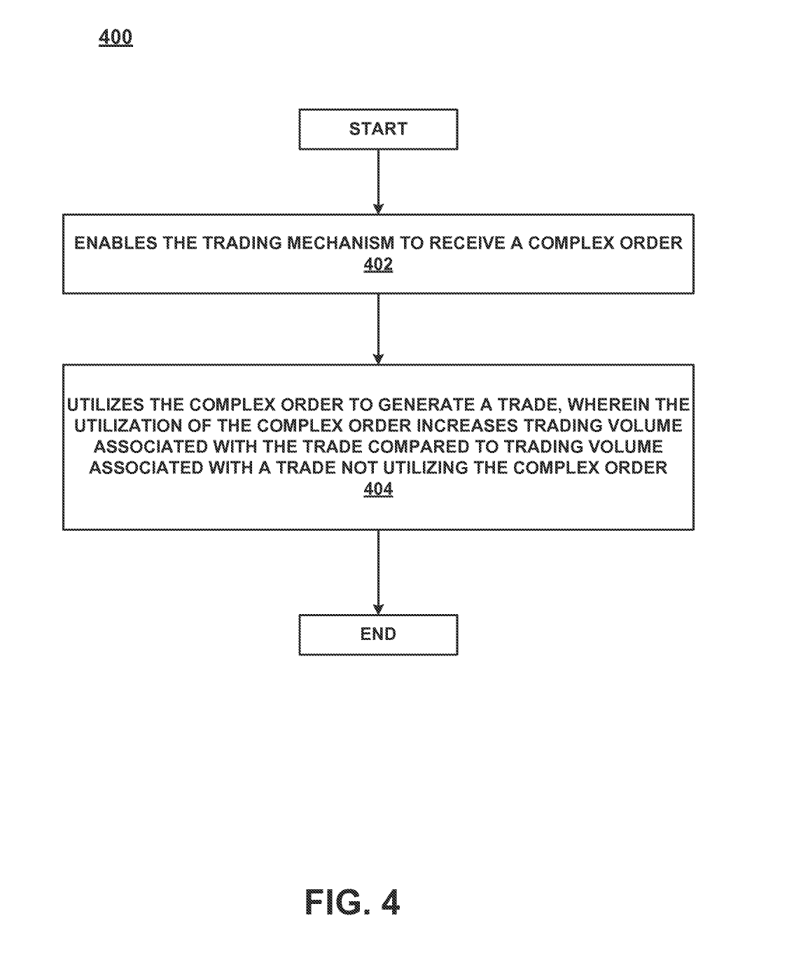

Referring to FIG. 4, a method 400 for increasing trade volume in a trading mechanism, said method comprising:

enabling 402 said trading mechanism to receive a complex order; and

utilizing 404 said complex order to generate a trade, wherein the utilization of said complex order increases trading volume associated with said trade compared to trading volume associated with a trade not utilizing said complex order.

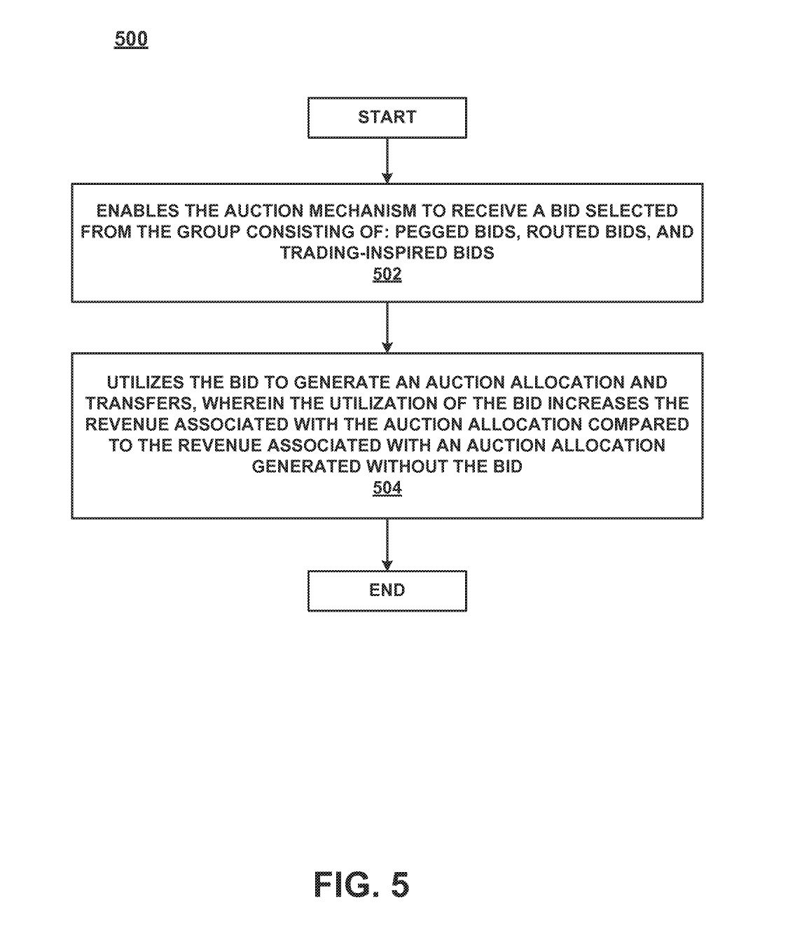

Referring to FIG. 5, a method 500 for increasing auction revenue in an auction mechanism, said method comprising:

enabling 502 said auction mechanism to receive a bid selected from the group consisting of: pegged bids, routed bids, and trading-inspired bids; and

utilizing 504 said bid to generate an auction allocation and transfers, wherein the utilization of said bid increases the revenue associated with said auction allocation compared to the revenue associated with an auction allocation generated without said bid.

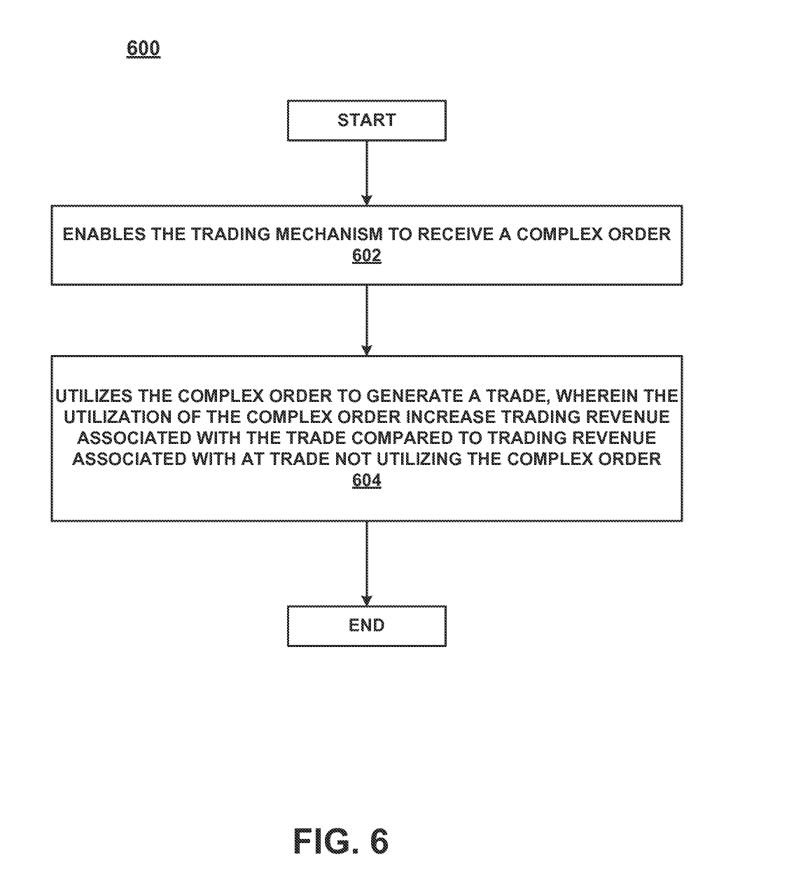

Referring to FIG. 6, a method 600 for enhancing revenue in a trading mechanism, said method comprising:

enabling 602 said trading mechanism to receive a complex order; and

utilizing 604 said complex order to generate a trade, wherein the utilization of said complex order increases trading revenue associated with said trade compared to trading revenue associated with a trade not utilizing said complex order.

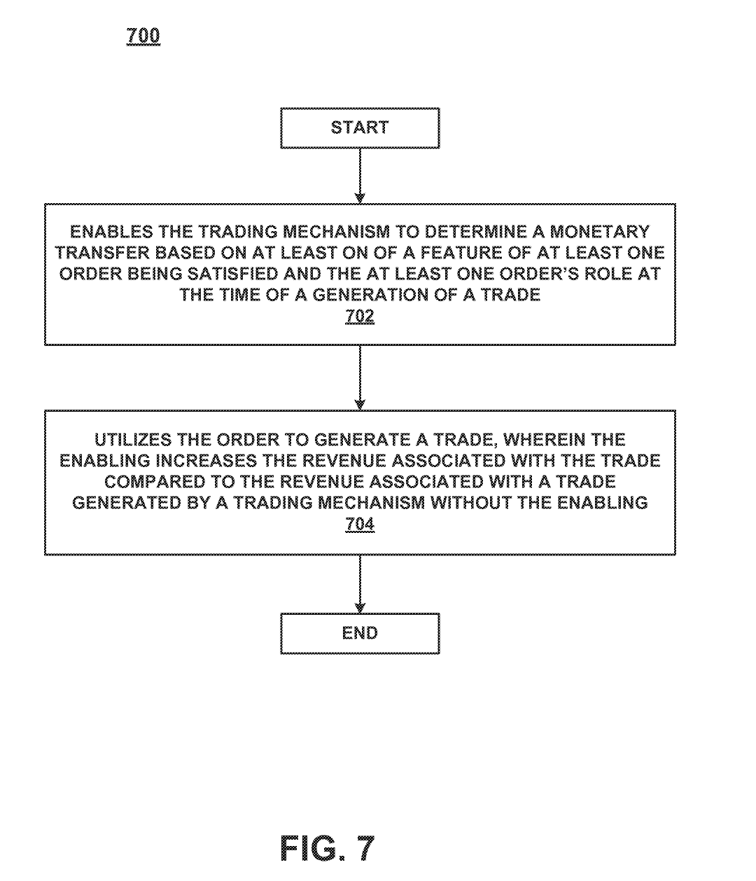

Referring to FIG. 7, a method 700 for increasing revenue of a trading mechanism, said method comprising:

enabling 702 said trading mechanism to determine a monetary transfer based on at least one of a feature of at least one order being satisfied and said at least one order's role at the time of a generation of a trade; and

utilizing 704 said order to generate a trade, wherein said enabling increases the revenue associated with said trade compared to the revenue associated with a trade generated by a trading mechanism without said enabling.

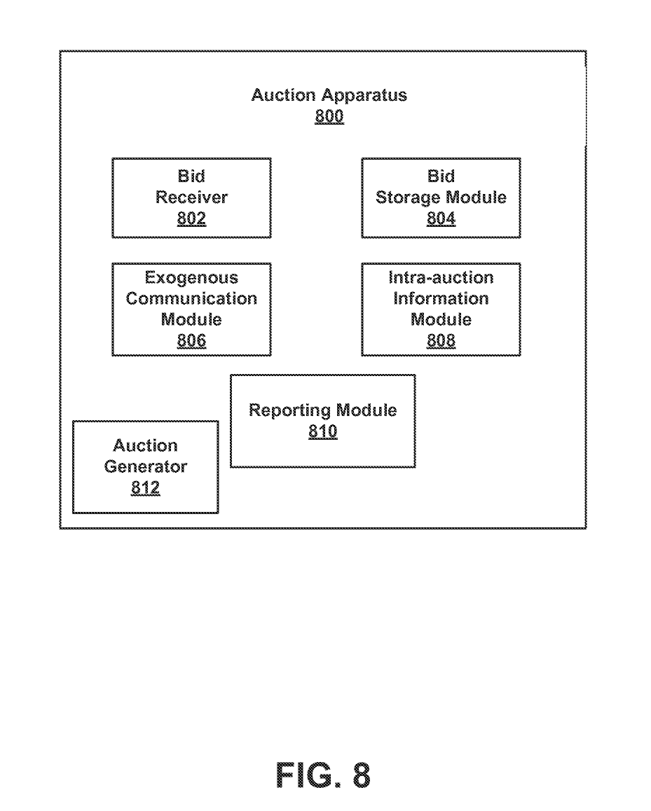

Referring to FIG. 8, an auction apparatus 800 comprising:
a bid receiver 802 configured for receiving bids from at least one bidder, said bids comprising at least one pegged bid;
a bid storage module 804 configured for storing said bids;
an auction generator 812 configured for generating auction allocations and transfers based on said bids and an auction mechanism;

at least one of an exogenous communication module 806 configured for communicating with a data feed and an 808 intra-auction information module configured for reporting and generating intra-auction information based on said bids and said auction allocations and transfers;

and a reporting module 810 configured for reporting said auction allocation and transfers.

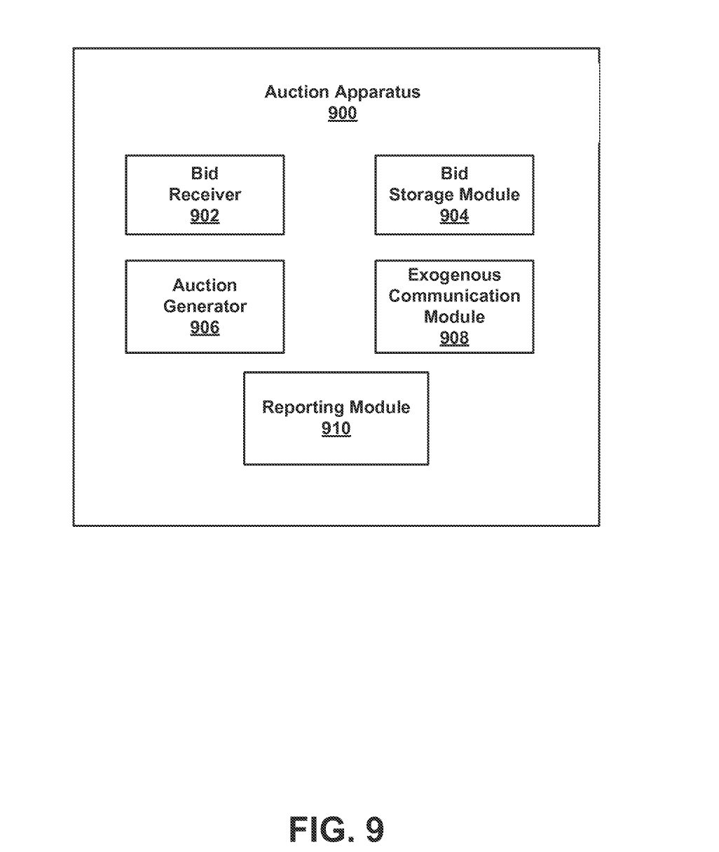

Referring to FIG. 9, an auction apparatus 900 comprising:
a bid receiver 902 configured for receiving bids from at least one bidder, said bids comprising at least one routed bid;
a bid storage module 904 configured for storing said bids;
an auction generator 906 configured for generating auction allocations and transfers based on said bids and an auction mechanism;

an exogenous communication module 908 configured for communicating with at least one of a trading venue other than a trading venue comprising said auction apparatus;

and a reporting module 910 configured for reporting said auction allocation and transfers.

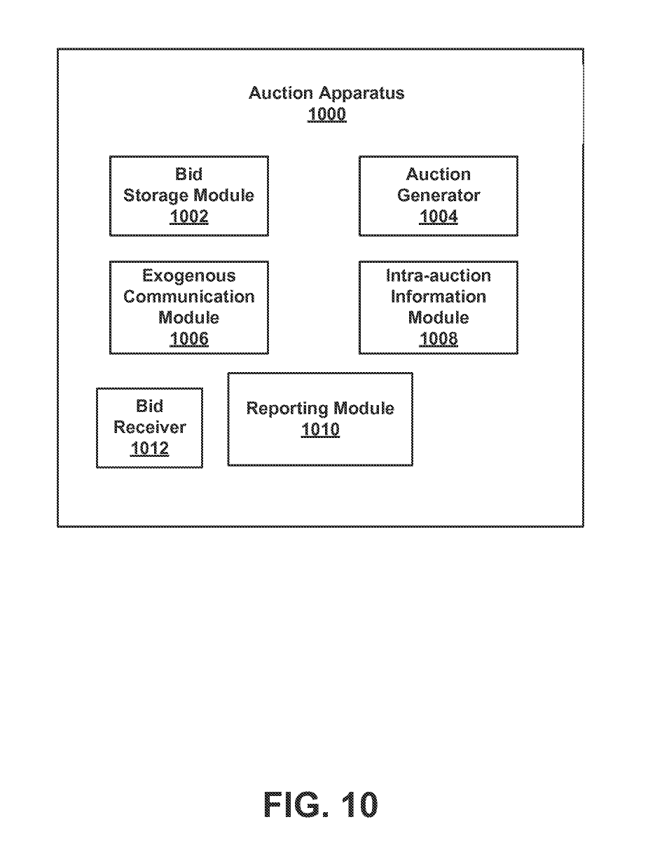

Referring to FIG. 10, an auction apparatus 1000 comprising:
a bid receiver 1012 configured for receiving bids from at least one bidder, said bids comprising at least one trading-inspired bid;
a bid storage module 1002 configured for storing said bids;
an auction generator 1004 configured for generating auction allocations and transfers based on said bids and an auction mechanism;

at least one of an exogenous communication module 1006 configured for communicating with at least one of a trading venue other than a trading venue comprising said auction apparatus and a data feed, and an intra-auction information module 1008 configured for reporting and generating intra-auction information based on said bids and said allocations and transfers;

and a reporting module 1010 configured for reporting said auction allocation and transfers.

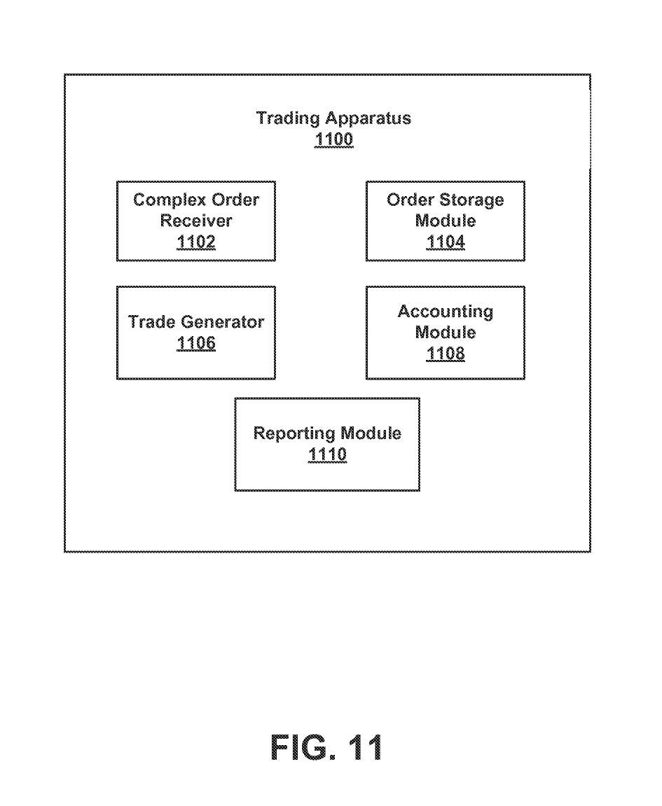

Referring to FIG. 11, a trading apparatus 1100 comprising:
a complex order receiver 1102 configured for receiving at least one order from at least one trader;
an order storage module 1104 configured for storing said at least one order;
a trade generator 1106 configured for generating trades based on said at least one order and a trading mechanism;
an accounting module 1108 configured for determining a monetary transfer based on at least one of a feature of said at least one order being satisfied and said at least one order's role at a time of said generating trades; and
a reporting module 1110 configured for reporting said trades.

### Example Computer System Environment

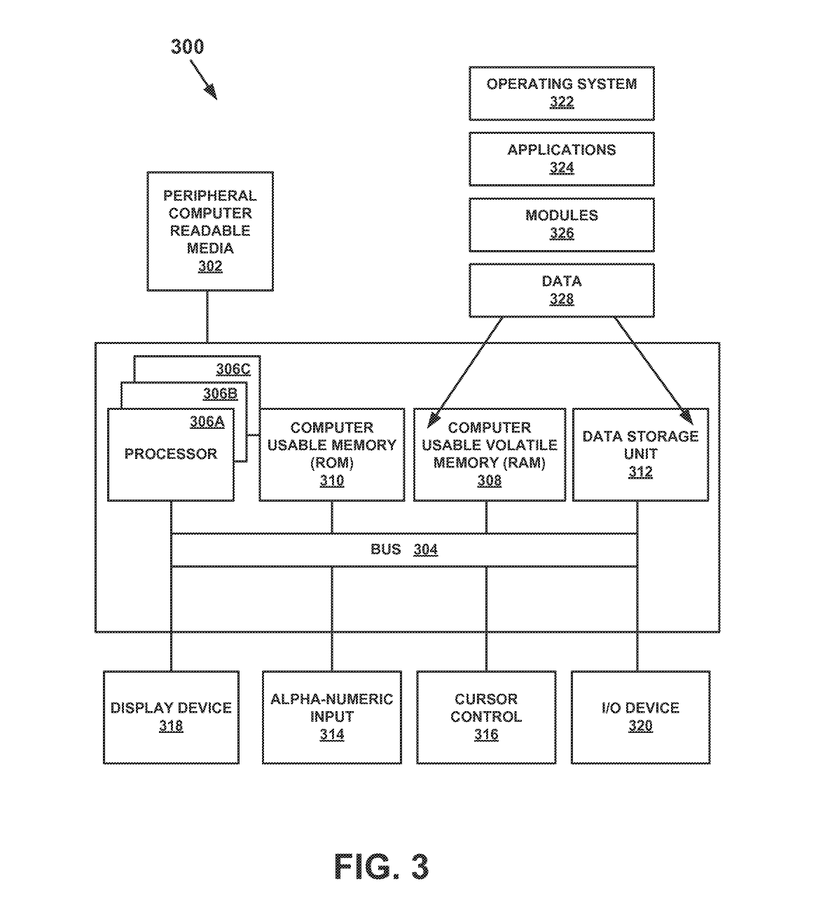

With reference now to FIG. 3, portions of the technology for trading are composed of computer-readable and computer-executable instructions that reside, for example, in computer-readable storage media of a computer system. That is, FIG. 3 illustrates one example of a type of computer that can be used to implement embodiments, which are discussed below, of the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand alone computer systems, and the like. As shown in FIG. 3, computer system 300 of FIG. 3 is well adapted to having peripheral computer readable media 302 such as, for example, a floppy disk, a compact disc, and the like coupled thereto.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. System 300 also includes data storage features such as a computer usable volatile memory 308, e.g. random access memory (RAM), coupled to bus 704 for storing information and instructions for processors 706A, 706B, and 706C.

System 300 also includes computer usable non-volatile memory 310, e.g. read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. System 300 also includes an optional alphanumeric input device 314 including alphanumeric and function keys coupled to bus 304 for communicating information and command selections to processor 306A or processors 306A, 306B, and 306C. System 300 also includes an optional cursor control device 316 coupled to bus 304 for communicating user input information and command selections to processor 306A or processors 306A, 306B, and 306C. System 300 of the present embodiment also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alphanumeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities. For example, in one embodiment, I/O device 320 is a modem for enabling wired or wireless communications between system 300 and an external network such as, but not limited to, the Internet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300. For example, a method for identifying a device associated with a transfer of content may be applied to operating system 322, applications 324, modules 326, and/or data 328.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the exemplary embodiments shown and described herein. Rather, the scope and spirit of present technology is embodied by the appended claims.

Various embodiments in accordance with the preset invention can be described as follows:

1. A trading apparatus supporting orders from either multi-unit orders, multi-item orders, or a combination of multi-unit orders and multi-item orders, and having a trading mechanism including a message space that defines admissible orders, said trading apparatus comprising:
a) an order receiver for receiving admissible orders from at least one trader i, said orders comprising at least one admissible complex order submitted by said trader i,
   1) said complex order involving at least one nonzero price and belonging to the group of either multi-unit orders, multi-item orders, or a combination of multi-unit orders and multi-item orders;
   2) said complex order including at least one complex condition defined on a state of the world at a clearing;
      wherein, given said trading mechanism:
   3) for at least one set of orders in the set of admissible orders from traders other than trader i, determining whether said complex condition is met is not possible knowing only the information contained in the group of
      trader i's allocation and transfers in said clearing,
      trader i's own order history up until the time of said clearing,
      the time of said clearing,
      the history of exogenous variables up until the time of said clearing,
      and other information available to trader i in said trading mechanism up until the time of said clearing;
      but is possible knowing the information contained in the group of the trade allocation and transfers in said clearing, and the entirety of trading mechanism information up until the time of said clearing;
b) an order storage module for storing said admissible submitted orders;
c) a trade generator for generating trades based on said admissible submitted orders and said trading mechanism; and
d) a reporting module for reporting said trades.
   2. The trading apparatus of Claim 1, further comprising:

an order manager configured for managing an event associated with said orders selected from the group consisting of:
submission of said orders; amendment of said orders; cancelling of said orders; generating a set of valid outstanding orders; confirming a receipt of said orders; publishing of a portion of said orders; and a trade generated based on said orders.
   3. The trading apparatus of Claim 1, further comprising:

an intra-trade information module configured for reporting and generating intra-trade information based on at least one of said orders and said trades.

4. The trading apparatus of Claim 1, further comprising:

an exogenous communication module configured for communicating with at least one of an exogenous trading venue and a data feed, said exogenous trading venue being one other than a trading venue comprising said trading apparatus.

5. The trading apparatus of Claim 4, wherein said exogenous communication module comprises:

an order routing module configured for sending a portion of said orders to said exogenous trading venue; and

an exogenous information accessor configured for accessing information from at least one of said exogenous trading venue and said data feed.

6. The trading apparatus of Claim 1, further comprising:

a trading mechanism storage module configured for storing said trading mechanism.

7. The trading apparatus of Claim 6, wherein said trading mechanism storage module is configured to be accessible by said trade generator.
8. The trading apparatus of Claim 1, further comprising:

a selectable order input form configured for being selected by said at least one trader.

9. The trading apparatus of Claim 8, wherein said selectable order input form is selected from the group of selectable order input forms consisting of:

a sentence specifier; a mathematical condition specifier; a function specifier; a range specifier; and a trade objective of said at least one trader.

10. The trading apparatus of Claim 1, further comprising:

a trade storage module configured for storing information associated with said trades.

11. The trading apparatus of Claim 1, further comprising:
an instruction receiver configured for receiving trade reporting instructions.
   12. The trading apparatus of Claim 1, wherein said trade generator comprises:

a comparator configured for comparing stored orders with said trading mechanism; and

a trade executor configured for executing said trades based on said comparing.

13. The trading apparatus of Claim 1, wherein said trade generator comprises:

a clearing method module configured for executing a clearing method.

14. The trading apparatus of Claim 1, wherein said trading mechanism comprises:

a clearing method.

15. The trading apparatus of Claim 14, wherein said clearing method comprises at least one of the following: a trading format, a trading objective and a tie breaker.
16. The trading apparatus of Claim 15, wherein said trading format utilized by said trading apparatus is selected from the group consisting of:

a first price auction format; a second price auction format; a first price combinatorial auction format; a second price combinatorial auction format; a discriminatory price auction format; a uniform price auction format; a discriminatory price combinatorial auction format; a uniform price combinatorial auction format; and a combinatorial auction format.

17. The trading apparatus of Claim 15, wherein said trading format utilized by said trading apparatus is selected from the group consisting of:

an exchange format; a trading format in which orders submitted consist only of quantities; NYSE Matchpoint; and platforms that send out intra-trading information that is partly based on orders currently in the system.

18. The trading apparatus of Claim 15, wherein the optimization of said trading objective involves the consideration of an effect of said generated trades on at least one criterion, said criterion selected from the group consisting of:

auctioneer revenue; auctioneer cost; gains from trade; trade volume; maximizing auctioneer revenue; equity; dispersion; and price stability.

19. The trading apparatus of Claim 1, wherein said trading mechanism comprises:

at least one trading rule associated with said trading mechanism.

20. The trading apparatus of Claim 19, wherein said at least one trading rule associated with said trading mechanism is selected from the group consisting of:

rules regarding orders; rules regarding monetization; rules regarding a candidate set of items; and rules regarding when to clear a trade.

21. The trading apparatus of Claim 1, wherein each of said at least one complex order comprises:

at least one complex condition and at least one condition that is non-complex selected from the group consisting of:
pegging conditions; routing conditions; trade-inspired conditions; a minimum execution size; and a bundle condition.
   22. The trading apparatus of Claim 1, wherein said trading apparatus operates in at least one round of a dynamic auction.
   23. The trading apparatus of Claim 1, wherein said orders are for items selected from the group consisting of:

public sector bonds, private sector bonds; bills; notes; stocks; exchange traded funds; derivatives; options; credit default swaps, variance swaps; commodities; power; oil drilling rights; emission allowances; emission credits; real estate; online advertising spots; patents; spectrum licenses; airport landing spots; data capacity; other tangible goods; and other intangible goods.

24. The trading apparatus of Claim 1, wherein said trading apparatus is configured for operation in a rich setting.
25. The trading apparatus of Claim 1, wherein said order receiver is configured for receiving at least one complex order having a condition selected from the group of condition categories consisting of:

items bought; items sold; the auction allocation and transfers; statistics derived from information contained in said orders; variables whose calculation requires utilizing at least some information included in said orders; item-less trades; features of orders matched with said at least one complex order; and impact on intra-trade information.

26. The trading apparatus of Claim 1, wherein said order receiver is configured for receiving said at least one complex order having a condition on a variable that captures a concept selected from the group consisting of:

price impact of an order; auction depth; market depth; liquidity; oversubscription; level of competition; equity; dispersion; supply-demand-imbalance; stability; and momentum.

27. A non-transitory computer-readable storage medium comprising instructions stored thereon which, when executed by a computer system, cause said computer system to perform a trading method supporting orders from either multi-unit orders, multi-item orders, or a combination of multi-unit orders and multi-item orders, said trading method comprising:
a) providing a trading mechanism including a message space that defines admissible orders;
b) receiving admissible orders from at least one trader i, wherein said orders comprise at least one admissible complex order submitted by said trader i,
   1) said complex order involving at least one nonzero price and belonging to the group of either multi-unit orders, multi-item orders, or a combination of multi-unit orders and multi-item orders;
   2) said complex order including at least one complex condition defined on a state of the world at a clearing;
      wherein given said trading mechanism:
   3) for at least one set of orders in the set of admissible orders from traders other than trader i, determining whether said complex condition is met is not possible knowing only the information contained in the group of
      trader i's allocation and transfers in said clearing,
      trader i's order history up until the time of said clearing,
      other information available to trader i in said trading mechanism up until the time of said clearing,
      the time of said clearing,
      and the history of exogenous variables up until the time of said clearing;
      but is possible using the information contained in the group of the trade allocation and transfers in said clearing, and the entirety of trading mechanism information up until the time of said clearing;
c) storing said admissible orders;
d) generating trades based on said admissible submitted orders and said trading mechanism; and
e) reporting said trades.
   28. The trading method of Claim 27, further comprising:

managing an event associated with said orders selected from a group of events consisting of:
submission of said orders; amendment of said orders; cancellation of said orders; generation of a set of valid outstanding orders; confirmation of a receipt of said orders; publication of a portion of said orders; and a trade generated based on said orders.
   29. The trading method of Claim 27, further comprising:

generating and reporting intra-trade information based on at least one of said orders and said trades.

30. The trading method of Claim 27, further comprising:

communicating with at least one of an exogenous trading venue and a data feed, said exogenous trading venue being one other than a trading venue comprising said trading apparatus.

31. The trading method of Claim 30, wherein said communicating comprises:

sending a portion of said orders to said exogenous trading venue; and

accessing information from at least one of said trading venue and said data feed.

32. The trading method of Claim 27, further comprising:

storing said trading mechanism.

33. The trading method of Claim 27, further comprising:

receiving a selection of a selectable order input by said at least one trader.

34. The trading method of Claim 27, further comprising:

storing information associated with said trades.

35. The trading method of Claim 27, further comprising:

receiving trade reporting instructions.

36. The trading method of Claim 27, wherein said generating trades based on said orders and a trading mechanism comprises:

comparing stored orders with said trading mechanism; and

executing said trades based on said comparing.

37. The trading method of Claim 27, wherein said generating trades based on said orders and a trading mechanism comprises:

executing a clearing method.

38. The trading method of Claim 27, wherein said reporting said trades comprises:

reporting said trades to said at least one trader.

39. The trading method of Claim 27, wherein said method comprises operating in at least one round of a dynamic auction.
40. The trading method of Claim 27, wherein said method comprises operating in a rich setting.
41. A computer-implemented method for trading, supporting orders from either multi-unit orders, multi-item orders, or a combination of multi-unit orders and multi-item orders comprising:
a) providing a trading mechanism including a message space that defines admissible orders;
b) receiving admissible orders from at least one trader i, said orders comprising at least one admissible complex order submitted by said trader i,
   1) said complex order involving at least one nonzero price and belonging to the group of either multi-unit orders, multi-item orders, or a combination of multi-unit orders and multi-item orders;
   2) said complex order including at least one complex condition defined on a state of the world at a clearing;
      wherein, given said trading mechanism:
   3) for at least one set of orders in the set of admissible orders from traders other than trader i, determining whether said complex condition is met is not possible knowing only the information contained in the group of
      trader i's allocation and transfers in said clearing,
      trader i's order history up until the time of said clearing,
      other information available to trader i in said trading mechanism up until the time of said clearing,
      the time of said clearing,
      and the history of exogenous variables up until the time of said clearing;
      but is possible using the information contained in the group of the trade allocation and transfers in said clearing, and the entirety of trading information up until the time of said clearing;
c) storing said at least one admissible complex order in an order storage module configured for storing said admissible orders;
d) generating trades based on said at least one admissible submitted complex order and said trading mechanism; and
e) reporting said trades with a reporting module.
   42. The method of Claim 41, further comprising:

managing an event associated with said orders selected from a group of events consisting of:

submission of said orders; amendment of said orders; cancellation of said orders; generation of a set of valid outstanding orders; confirmation of a receipt of said orders; publication of a portion of said orders; and a trade generated based on said orders.

43. The trading method of Claim 41, further comprising:

reporting and generating intra-trade information based on at least one of said orders and said trades.

44. The trading method of Claim 41, further comprising:

communicating with at least one of a trading venue, said trading venue being one other than a trading venue comprising said trading apparatus, and a data feed.

45. The trading method of Claim 44, wherein said communicating comprises:

sending a portion of said orders to said trading venue; and

accessing information from at least one of said trading venue and said data feed.

46. The trading method of Claim 41, further comprising:

storing said trading mechanism.

47. The trading method of Claim 41, further comprising:

receiving a selection of a selectable order input from by said at least one trader.

48. The trading method of Claim 41, further comprising:

storing information associated with said trades.

49. The trading method of Claim 41, further comprising:

receiving trade reporting instructions.

50. The trading method of Claim 41, wherein said generating trades based on said orders and a trading mechanism comprises:

comparing stored orders with said trading mechanism; and

executing said trades based on said comparing.

51. The trading method of Claim 41, wherein said generating trades based on said orders and a trading mechanism comprises:

executing a clearing method.

52. The trading method of Claim 41, wherein said method comprises operating in at least one round of a dynamic auction.
53. The trading method of Claim 41, wherein said method comprises operating in a rich setting.
54. A method for increasing trade volume in a trading mechanism, said method comprising:

enabling said trading mechanism to receive a complex order; and

utilizing said complex order to generate a trade, wherein the utilization of said complex order increases trading volume associated with said trade compared to trading volume associated with a trade not utilizing said complex order.

55. A method for increasing auction revenue in an auction mechanism, said method comprising:

enabling said auction mechanism to receive a bid selected from the group consisting of: pegged bids, routed bids, and trading-inspired bids; and

utilizing said bid to generate an auction allocation and transfers, wherein the utilization of said bid increases the revenue associated with said auction allocation compared to the revenue associated with an auction allocation generated without said bid.

56. A method for enhancing revenue in a trading mechanism, said method comprising:

enabling said trading mechanism to receive a complex order; and

utilizing said complex order to generate a trade, wherein the utilization of said complex order increases trading revenue associated with said trade compared to trading revenue associated with a trade not utilizing said complex order.

57. A method for increasing revenue of a trading mechanism, said method comprising:

enabling said trading mechanism to determine a monetary transfer based on at least one of a feature of at least one order being satisfied and said at least one order's role at the time of a generation of a trade; and

utilizing said order to generate a trade, wherein said enabling increases the revenue associated with said trade compared to the revenue associated with a trade generated by a trading mechanism without said enabling.

58. An auction apparatus comprising:
a bid receiver configured for receiving bids from at least one bidder, said bids comprising at least one pegged bid;
a bid storage module configured for storing said bids;
an auction generator configured for generating auction allocations and transfers based on said bids and an auction mechanism;

at least one of an exogenous communication module configured for communicating with a data feed and an intra-auction information module configured for reporting and generating intra-auction information based on said bids and said auction allocations and transfers;

and a reporting module configured for reporting said auction allocation and transfers.

59. An auction apparatus comprising:
a bid receiver configured for receiving bids from at least one bidder, said bids comprising at least one routed bid;
a bid storage module configured for storing said bids;
an auction generator configured for generating auction allocations and transfers based on said bids and an auction mechanism;

an exogenous communication module configured for communicating with at least one of a trading venue other than a trading venue comprising said auction apparatus;

and a reporting module configured for reporting said auction allocation and transfers.

60. An auction apparatus comprising:
a bid receiver configured for receiving bids from at least one bidder, said bids comprising at least one trading-inspired bid;
a bid storage module configured for storing said bids;
an auction generator configured for generating auction allocations and transfers based on said bids and an auction mechanism;

at least one of an exogenous communication module configured for communicating with at least one of a trading venue other than a trading venue comprising said auction apparatus and a data feed, and an intra-auction information module configured for reporting and generating intra-auction information based on said bids and said allocations and transfers;

and a reporting module configured for reporting said auction allocation and transfers.

61. A trading apparatus comprising:
a complex order receiver configured for receiving at least one order from at least one trader;
an order storage module configured for storing said at least one order;
a trade generator configured for generating trades based on said at least one order and a trading mechanism;
an accounting module configured for determining a monetary transfer based on at least one of a feature of said at least one order being satisfied and said at least one order's role at a time of said generating trades; and
a reporting module configured for reporting said trades.

1. A trading apparatus supporting orders from either multi-unit order, multi-item orders, or a combination of multi-unit orders and multi-item orders, and having a trading mechanism including a message space that defines admissible orders, said trading apparatus comprising:
a) an order receiver at said trading apparatus, for receiving admissible orders from at least one trader i, said orders comprising at least one admissible submitted complex order by said trader i,
1) said admissible submitted complex order involving at least one nonzero price and belonging to the group of either multi-unit orders, multi-item orders, or a combination of multi-unit orders and multi-item orders;
2) said admissible submitted complex order including at least one complex condition defined on a state of the world at a clearing;
wherein, given said trading mechanism:
3) for at least one set of orders in the set of admissible orders from traders other than trader i, determining whether said complex condition is met is not possible knowing only the information contained in the group of
trader i's allocation and transfers in said clearing,
trader i's own order history up until the time of said clearing,
the time of said clearing,
the history of exogenous variables up until the time of said clearing,
and other information available to trader i in said trading mechanism up until the time of said clearing,
but is possible knowing the information contained in the group of the trade allocation and transfers in said clearing, and the entirety of trading mechanism information up until the time of said clearing;
b) an order storage module at said trading apparatus for storing said admissible submitted orders;
c) a trade generator at said trading apparatus for generating trades based on said admissible submitted orders and said trading mechanism, wherein a price or prices corresponding to a generated trade allocations and transfers, for item or items on which said at least one admissible submitted complex order was submitted, are determined endogenously; and
d) a reporting module at said trading apparatus for reporting said trades.

2. A non-transitory computer-readable storage medium comprising instructions stored thereon which, when executed by a computer system, cause said computer system to perform a trading method supporting orders from either multi-unit orders, multi-item orders, or a combination of multi-unit orders and multi-item orders, said trading method comprising:
a) providing a trading mechanism at a trading apparatus including a message space that defines admissible orders;
b) receiving admissible orders at said trading apparatus from at least one trader i, wherein said orders comprise at least one admissible submitted complex order submitted by said trader i,
1) said admissible submitted complex order involving at least one nonzero price and belonging to the group of either multi-unit orders, multi-item orders, or a combination of multi-unit orders and multi-item orders;
2) said admissible submitted complex order including at least one complex condition defined on a state of the world at a clearing;
wherein, given said trading mechanism:
3) for at least one set of orders in the set of admissible orders from traders other than trader i, determining whether said complex condition is met is not possible knowing only the information contained in the group of trader i's allocation and transfers in said clearing,
trader i's own order history up until the time of said clearing,
the time of said clearing,
the history of exogenous variables up until the time of said clearing,
and other information available to trader i in said trading mechanism up until the time of said clearing,
but is possible knowing the information contained in the group of the trade allocation and transfers in said clearing, and the entirety of trading mechanism information up until the time of said clearing;
c) storing said admissible submitted orders at said trading apparatus;
d) generating trades at said trading apparatus based on said admissible submitted orders and said trading mechanism, wherein a price or prices corresponding to a generated trade allocations and transfers, for item or items on which said at least one admissible submitted complex order was submitted, are determined endogenously; and
e) reporting said trades.

3. A computer-implemented method for trading to be executed at a trading apparatus,
supporting orders from either multi-unit orders, multi-item orders, or a combination of multi-unit orders and multi-item orders comprising:
a) providing a trading mechanism at said trading apparatus including a message space that defines admissible orders;
b) receiving admissible orders at said trading apparatus from at least one trader i, said admissible orders comprising at least one admissible submitted complex order submitted by said trader i,
1) said admissible submitted complex order involving at least one nonzero price and belonging to the group of either multi-unit orders, multi-item orders, or a combination of multi-unit orders and multi-item orders;
2) said admissible submitted complex order including at least one complex condition defined on a state of the world at a clearing;
wherein, given said trading mechanism:
3) for at least one set of orders in the set of admissible orders from traders other than trader i, determining whether said complex condition is met is not possible knowing only the information contained in the group of
trader i's allocation and transfers in said clearing,
trader i's own order history up until the time of said clearing,
other information available to trader i in said trading mechanism up until the time of said clearing,
the time of said clearing, and
the history of exogenous variables up until the time of said clearing,
but is possible knowing the information contained in the group of the trade allocation and transfers in said clearing, and the entirety of trading mechanism information up until the time of said clearing;
c) storing said at least one admissible submitted complex order in an order storage module at said trading apparatus for storing said admissible orders;
d) generating trades at said trading apparatus based on said at least one admissible submitted complex order and said trading mechanism, wherein a price or prices corresponding to a generated trade allocations and transfers, for item or items on which said at least one admissible submitted complex order was submitted, are determined endogenously; and
e) reporting said trades with a reporting module at said trading apparatus.

4. A trading apparatus supporting orders from either multi-unit order, multi-item orders, or a combination of multi-unit orders and multi-item orders, and having a trading mechanism including a message space that defines admissible orders, said trading apparatus comprising:
a) an order receiver at said trading apparatus, for receiving admissible orders from at least one trader i, said orders comprising at least one admissible submitted complex order by said trader i,
1) said admissible submitted complex order involving at least one nonzero price and belonging to the group of either multi-unit orders, multi-item orders, or a combination of multi-unit orders and multi-item orders;
2) said admissible submitted complex order including at least one complex condition defined on a state of the world at a clearing;
wherein, given said trading mechanism:
3) said at least one admissible complex condition defined on a state of the world at a clearing cannot be defined solely as a condition on at least one of a generated trade allocation and transfers;
4) for at least one set of orders in the set of admissible orders from traders other than trader i, determining whether said complex condition is met is not possible knowing only the information contained in the group of
trader i's allocation and transfers in said clearing,
trader i's own order history up until the time of said clearing,
the time of said clearing,
the history of exogenous variables up until the time of said clearing,
and other information available to trader i in said trading mechanism up until the time of said clearing,
but is possible knowing the information contained in the group of the trade allocation and transfers in said clearing, and the entirety of trading mechanism information up until the time of said clearing;
b) an order storage module at said trading apparatus for storing said admissible submitted orders;
c) a trade generator at said trading apparatus for generating trades based on said admissible submitted orders and said trading mechanism, and
d) a reporting module at said trading apparatus for reporting said trades.

5. A trading apparatus supporting orders from either multi-unit order, multi-item orders, or a combination of multi-unit orders and multi-item orders, and having a trading mechanism including a message space that defines admissible orders, said trading apparatus comprising:
a) an order receiver at said trading apparatus, for receiving admissible orders from at least one trader i, said orders comprising at least one admissible submitted complex order by said trader i,
1) said admissible submitted complex order involving at least one nonzero price and belonging to the group of either multi-unit orders, multi-item orders, or a combination of multi-unit orders and multi-item orders;
2) said admissible submitted complex order including at least one complex condition defined on a state of the world at a clearing;
wherein, given said trading mechanism:
3) said state of the world is defined on at least a total quantity corresponding to a trade allocation; and wherein said complex condition is defined on the absolute value of said total quantity;
4) for at least one set of orders in the set of admissible orders from traders other than trader i, determining whether said complex condition is met is not possible knowing only the information contained in the group of
trader i's allocation and transfers in said clearing,
trader i's own order history up until the time of said clearing,
the time of said clearing,
the history of exogenous variables up until the time of said clearing,
and other information available to trader i in said trading mechanism up until the time of said clearing,
but is possible knowing the information contained in the group of the trade allocation and transfers in said clearing, and the entirety of trading mechanism information up until the time of said clearing;
b) an order storage module at said trading apparatus for storing said admissible submitted orders;
c) a trade generator at said trading apparatus for generating trades based on said admissible submitted orders and said trading mechanism, and
d) a reporting module at said trading apparatus for reporting said trades.
